(19) United States
(12) Patent Application Publication
(10) Pub. No.: US 2018/0011859 A1
(43) Pub. Date: Jan. 11, 2018

(54) DATABASE AND SYSTEM FOR VENUE COLLABORATION

(71) Applicant: First-Hold, Inc., West Palm Beach, FL (US)

(72) Inventors: Garry Hallinan, West Palm Beach, FL (US); Carl Wagner, Los Angeles, CA (US); Jennifer Brown, Alamo, CA (US)

(73) Assignee: First-Hold, Inc., West Palm Beach, FL (US)

(21) Appl. No.: 15/545,612

(22) PCT Filed: Jan. 27, 2016
(86) PCT No.: PCT/US2016/015139

§ 371 Date: Jul. 21, 2017

Related U.S. Application Data
(60) Provisional application No. 62/107,115, filed on Jan. 23, 2015.

(51) Int. Cl. G06F 17/30; G06Q 10/02

(52) U.S. Cl. CPC G06F 17/3056; G06F 17/30289; G06Q 10/02

(57) ABSTRACT

A networked database management system (DBMS) is disclosed. The DBMS may include a computer accessible data storage including a database, an access control module, a communication module, and a matching module. The database may be remotely located from a plurality of user nodes and a plurality of venue nodes. The remote database may include a plurality of records, wherein the records comprise: user node data, venue node data, and transaction data. The communication module may be in data communication with the data storage and may be configured to receive user node data and venue node data for storage in the database and query requests to retrieve user node data and venue node data from the database.

### CROSS-REFERENCE TO RELATED APPLICATIONS

This application is a national stage application, filed under 35 U.S.C. §371, of International Application No. PCT/US2016/015139, filed Jan. 27, 2016, which claims priority to U.S. Provisional Application No. 62/107,115, filed Jan. 23, 2015, the contents of which are hereby incorporated by reference in their entirety.

### BACKGROUND

### Field of Invention

Embodiments relate to databases, and in particular, configuring a database to manage interactions between external venue space nodes and external user end nodes.

### SUMMARY

Aspects of the invention may involve a networked database management system (DBMS). The DBMS may include, for example, a computer accessible data storage, comprising a database remotely located from a plurality of user nodes and a plurality of venue nodes, wherein the remote database comprises: a plurality of records, wherein the records comprise: user node data, venue node data, and transaction data; an access control module in data communication with the data storage and configured to prevent unauthorized access to the database; a communication module in data communication with the data storage and configured to receive user node data and venue node data for storage in the database and query requests to retrieve user node data and venue node data from the database; and a matching module in communication with the data storage and configured to: compare one or more venue objects to query information received from a first user node, provide one or more venue objects to the first user node via the communications module, set a hold on a venue object of the one or more venue objects for the first user node, prohibit assigning the venue object to the first user node if the venue object was held previously by one or more other user nodes, issue a challenge from the first user node to the one or more other user nodes that previously held the venue object, receive an accepted challenge from a second user node of the one or more other user nodes and release the hold on the venue obj ect for the first user node based on the accepted challenge, and create a transaction object and assign the venue object to the second user node using the transaction object.

In another embodiment, a networked system may be provided where a plurality of end nodes interface with a database. The system may include one or more processors; the database in communication with the one or more processors, the database comprising: one or more user objects, each user object including: a primary key field, a first name field, a last name field, an email field, a phone number field, and an address field, one or more venue objects, each venue object including: a primary key field, a foreign key field, and an address field, one or more transaction objects, each transaction object including: a primary key field and one or more foreign key fields; a memory in communication with the one or more processors, the memory containing instructions executable by the one or more processors to: create a plurality of venue objects based on received venue data, the venue data being received by one or more venue nodes of the plurality of end nodes; create a plurality of user objects based on received user data, the user data being received by one or more user nodes of the plurality of end nodes; search the plurality of venue objects based on received location information, date range, and number of attendees from the one or more user nodes and retrieve available venues from the database based on the location information, date range, and number of attendees; provide the available venues to the one or more user nodes; create a first transaction object based on a received first hold request from a first user node for a selected venue on a selected date and place a first hold on the selected venue on the selected date for the first user node; create a second transaction object based on a received second hold request from a second user node for the selected venue on the selected date and place a second hold on the selected venue on the selected date for the second user node; create a third transaction object based on a received third hold request from a third user node for the selected venue on the selected date and place a third hold on the selected venue on the selected date for the third user node; create a challenge request for the third user node to the first user node and the second user node; transmit the challenge request to the first user node and the second user node; receive an accepted challenge from the second user node; release the third hold on the selected venue on the selected date after the accepted challenge by the second user node; transmit a first notice of a release of the third hold to the third user node; release the first hold on the selected venue on the selected date after a period of time from the transmission of the challenge to the first user node; transmit a second notice of a release of the first hold to the first user node; and transmit a notice of acceptance to the second user node after receipt of the accepted challenge and after the period of time from the transmission of the challenge to the first user node.

In yet another embodiment, a database device may include a communication module in communication with a plurality of venue nodes and a plurality of user nodes; one or more processors; a database in communication with the one or more processors, the database comprising: one or more user objects, each user object including: a primary key field, a first name field, a last name field, an email field, a phone number field, and an address field, one or more venue objects, each venue object including: a primary key field, a foreign key field, and an address field, one or more transaction objects, each transaction object including: a primary key field and one or more foreign key fields; a memory in communication with the one or more processors, the memory containing instructions executable by the one or more processors to: create a plurality of venue objects based on received venue data, the venue data being received by the plurality of venue nodes; create a plurality of user objects based on received user data, the user data being received by the plurality of user nodes; search the plurality of venue objects based on received location information, date range, and number of attendees from one or more user nodes of the plurality of user nodes and retrieve available venues from the database based on the location information, date range, and number of attendees; provide the available venues to the one or more user nodes; create a first transaction object based on a received first hold request from a first user node for a selected venue on a selected date and place a first hold on the selected venue on the selected date for the first user node; create a second transaction object based on a received second hold request from a second user node for the selected venue on the selected date and place a second hold on the selected venue on the selected date for the second user node; create a third transaction object based on a received third hold request from a third user node for the selected venue on the selected date and place a third hold on the selected venue on the selected date for the third user node; create a challenge request for the third user node to the first user node and the second user node; transmit the challenge request to the first user node and the second user node; receive an accepted challenge from the second user node; release the third hold on the selected venue on the selected date after the accepted challenge by the second user node; transmit a first notice of a release of the third hold to the third user node; release the first hold on the selected venue on the selected date after a period of time from the transmission of the challenge to the first user node; transmit a second notice of a release of the first hold to the first user node; and transmit a notice of acceptance to the second user node after receipt of the accepted challenge and after the period of time from the transmission of the challenge to the first user node.

### BRIEF DESCRIPTION OF THE DRAWINGS

The foregoing and other features and advantages of the invention will be apparent from the following, more particular description of various exemplary embodiments, as illustrated in the accompanying drawings wherein like reference numbers generally indicate identical, functionally similar, and/or structurally similar elements. The first digits in the reference number indicate the drawing in which an element first appears.

FIG. 1 depicts a block diagram of a database system representing communications between database and various nodes via a network in an embodiment of the invention;

FIG. 2 depicts a block diagram of an embodiment of a database management system in an embodiment of the invention;

FIG. 3 depicts a database schema in an embodiment of the invention;

FIG. 4 depicts another database schema in an embodiment of the invention;

FIG. 5 depicts an example hold, challenge, release scenario in an embodiment of the invention;

FIG. 6 depicts an example workflow in an embodiment of the invention;

FIG. 7 depicts another example workflow in an embodiment of the invention;

FIG. 8 depicts an example venue search page in an embodiment of the invention;

FIG. 9 depicts a sample screen shot of a login page in an embodiment of the invention;

FIG. 10 depicts a sample screen shot of a customer dashboard in an embodiment of the invention;

FIG. 11 depicts a sample screen shot of a search result page in an embodiment of the invention;

FIG. 12 depicts a sample screen shot of an availability calendar in an embodiment of the invention;

FIG. 13 depicts a sample screen shot of a customer dashboard for holding or booking a venue in an embodiment of the invention;

FIG. 14 depicts a sample confirmation screen in an embodiment of the invention;

FIG. 15 depicts a sample screen shot of the availability calendar after a hold is placed in an embodiment of the invention;

FIG. 16 depicts a sample screen shot showing a challenge hold option in an embodiment of the invention;

FIG. 17 depicts a sample screen shot for entering credit card information and paying a deposit in an embodiment of the invention;

FIG. 18 depicts a sample screen shots showing a message when a hold has been successfully challenged and details of the issued challenge from a customer dashboard;

FIG. 19 depicts a sample screen shot informing a customer that a held venue is being challenged in an embodiment of the invention;

FIG. 20 depicts a sample screen shot informing a customer that the venue was successfully booked in an embodiment of the invention;

FIG. 21 depicts a sample screen shot to add venue detail in an embodiment of the invention;

FIG. 22 depicts a sample screen shot to add venue pricing in an embodiment of the invention;

FIG. 23 depicts a sample screen shot to add additional venue information in an embodiment of the invention;

FIG. 24 depicts a sample screen shot to add venue photographs in an embodiment of the invention;

FIG. 25 depicts a sample screen shot to add venue availability information;

FIG. 26 depicts an illustrative embodiment of a computer for performing the techniques and building the systems described herein in an embodiment of the invention; and

FIG. 27 depicts an illustrative network for use with methods and systems described herein.

### DESCRIPTION OF THE EMBODIMENTS

Exemplary embodiments are discussed in detail below. While specific exemplary embodiments are discussed, it should be understood that this is done for illustration purposes only. In describing and illustrating the exemplary embodiments, specific terminology is employed for the sake of clarity. However, the embodiments are not intended to be limited to the specific terminology so selected. A person skilled in the relevant art will recognize that other components and configurations may be used without parting from the spirit and scope of the embodiments. It is to be understood that each specific element includes all technical equivalents that operate in a similar manner to accomplish a similar purpose. The examples and embodiments described herein are non-limiting examples.

All publications cited herein are hereby incorporated by reference in their entirety.

As used herein, the term “a” refers to one or more. The terms “including,” “for example,” “such as,” “e.g.,” “may be” and the like, are meant to include, but not be limited to, the listed examples. The term “product” may refer to both products and services.

The following terms may be used. Venues: these may include meeting rooms, ballrooms, halls, buildings, rooms, houses, cabins, or other spaces, that may be available to use or rent for a selected period of time. Visitors: these are the users, who may browse the website and read information about the venues, search venues, read about the website services, and contact website administration via a form, for example. Customers: These are the users who may use the website to reserve or hold one or more spaces or for confirming a space. Customers may have to sign-up before making any booking or holding a space. Customers may get a login ID and password to access an account. Venue owners: These are the users, who may use the website to put up venues for booking, display all relevant details for each venue, and/or receive booking/hold date queries. Venue owners may be any entity wishing to engage a customer in a commercial relationship. Venue owners may receive a login ID and password to login to access the account and manage venues. Hold, challenge & release: is a technique for optimizing venue space, ensuring that the space is reserved for the customer who is willing to purchase the venue. User end node may include the hardware and software that a customer may use to interface with an embodiment of the invention. Venue space node may include the hardware and software that a venue owner may use to interface with an embodiment of the invention.

The systems and processes described herein may be created using the following development technologies, for example, PHP, Cake PHP, MySQL, JavaScript, CSS 3, and HTML 5. Additionally, other development technologies well known to those skilled in the art may also be used to create the systems and processes described herein.

Currently, no techniques exist to allow multiple user end nodes and multiple venue space nodes to interact with a centralized storage system to efficiently manage venue allocation. For example, multiple user end nodes may reserve multiple spaces as designated by multiple venue space nodes. Further, multiple user end nodes may reserve the same space at the same time. Additionally, each venue space node may have multiple areas available, some of which may be combined. Therefore, techniques are needed to allow the real-time, rational, and efficient distribution of multiple venue spaces to multiple user end nodes. An embodiment of the invention may provide the real-time, rational, and efficient distribution of a plurality of venues with a plurality of available spaces to multiple user end nodes.

In one example, there may be multiple different types of special event venues in any city or major metro area, for example, the San Francisco Bay Area. These venues may vastly vary in scope, size, availability, and cost to rent for private events. Currently, to plan a special event, a potential customer has to know of the venue and then make contact with someone affiliated with the venue to coordinate booking of that venue on specific dates. Venues also need to provide information to customers on the venue such as available dates, capacity, etc. Venues also need a way to communicate booking details and collect money (e.g., a deposit or down payment) from the customers. Venues need to optimize the booking process such that potential customers that place a hold on a venue on a particular date, actually follow through with the purchase of the venue. Often a contention may occur when two or more potential customers request a venue on the same date and time. In such a case a challenge may occur prompting one or more of the potential customers to engage the venue by finalizing the reservation (e.g., sign an agreement and pay an initial deposit or down payment). Hold, challenge & release (HCR) may be the order in which a business inquiry is received and the manner in determining who is awarded the venue's event space. HCR may be the order of operation for holding space at a venue. For example, two or more customers may be vying for the same venue's event space. A first customer may have the right of first refusal and under certain parameters that customer may forfeit their position so that the right is passed to another customer.

Several different techniques were developed including unique algorithms, database structures, and web interface pages. One algorithm includes a hold-challenge-book technique. In this technique, a first hold may have been placed on a space. Subsequently a second hold may be placed on the same space at the same time. The second hold may issue a challenge to the first hold. At which point, the first hold must execute a commitment to book the first hold space if the first hold space is desired. Otherwise, the challenge then goes to the next user that reserved the space. If no challenges are met, the second hold then books the space. A further complication may arise when the venue has multiple spaces (e.g., a large room that may be divided into several smaller rooms). Techniques have been derived to coordinate the handling of holding (as well as booking) all or a subset of the spaces per venue. For example, if user A holds space one of three before user B books space one, two, and three (user B must have all three), user B will need to issue a challenge to user A for space one in conjunction with booking space two and three. Additionally, an algorithm was needed to handle hold-release-book scenario. In one embodiment, a customer may first hold multiple dates with multiple event spaces. The customer may then release one or more of the event spaces. When this happens, the released dates may be forwarded to other users who also showed interest for those dates for that particular event space. Each date may be further divided up into, for example, three time slots, morning, afternoon, and evening. Other time divisions may also be made (e.g., hourly). Listed below are several selections of computer code that represent an embodiment of several techniques and algorithms to accomplish the above processes. For example, the first code snippet demonstrates an embodiment of a hold, challenge, and book algorithm. The second code snippet demonstrates an embodiment of a hold, release, and book algorithm. The last code snippet demonstrates an embodiment of buyout and non-buyout.

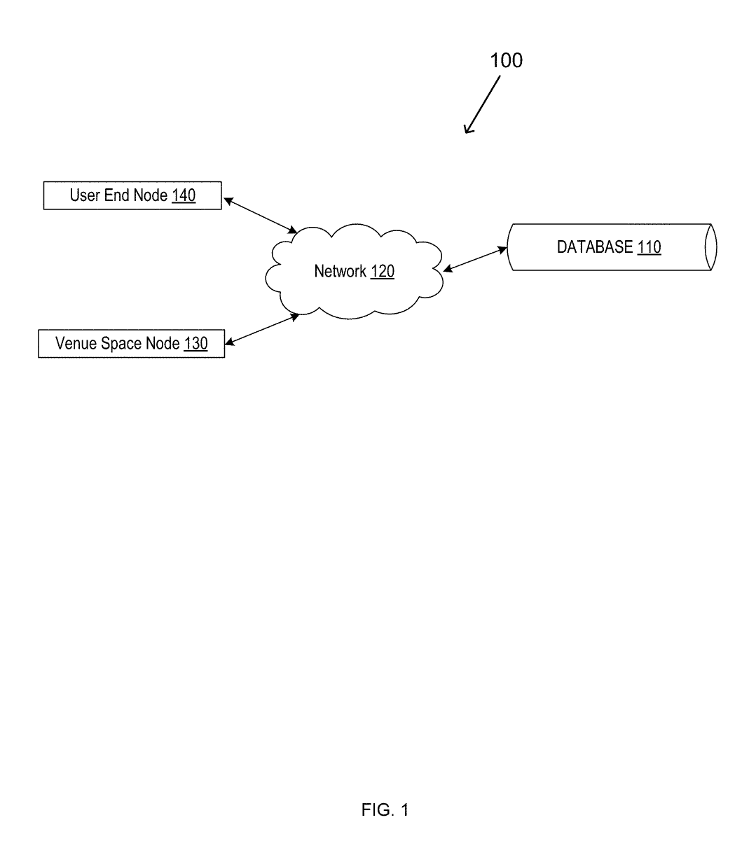

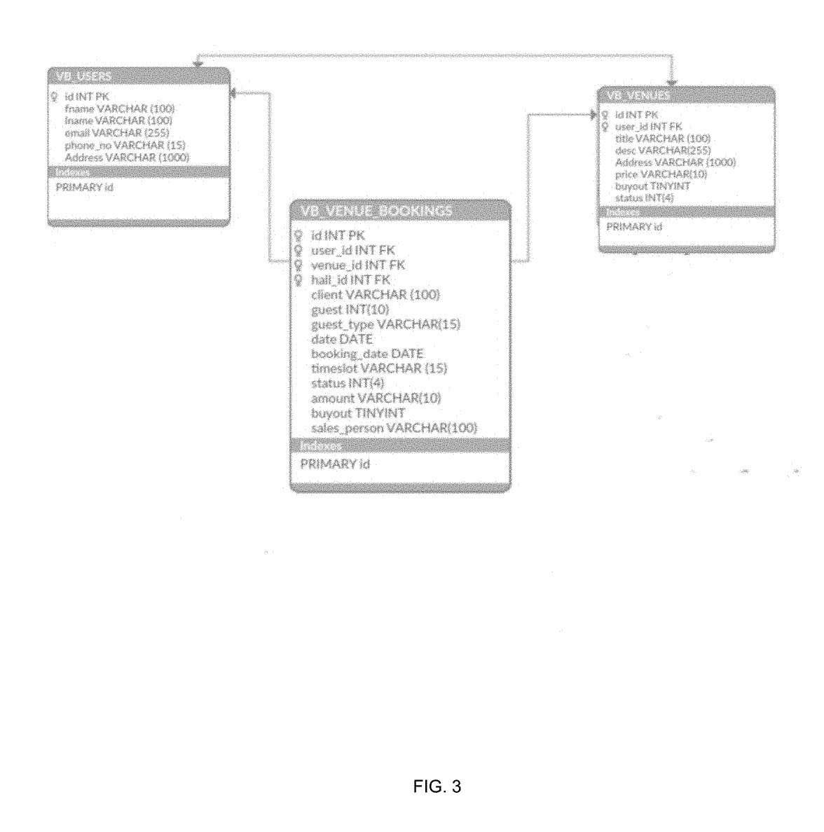

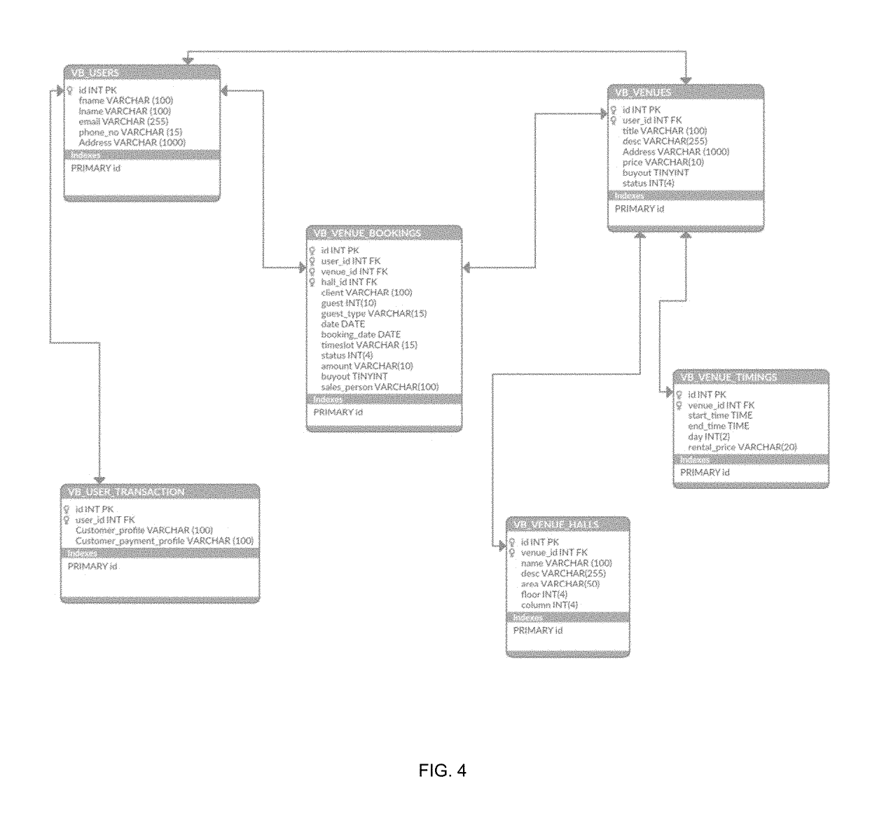

FIG. 1 depicts a block diagram of database system 100 representing communications between database 110 (e.g., database management system, DBMS), user end node 140, and venue space node 130, via network 120. Database 110 may be configured as shown in the database schemas of FIGS. 3-4. Venue space node 130 may include one or more devices (e.g., hardware and software) that a venue owner may use to interface with network 120 and database 110. User end node 140 may include one or more devices (e.g., hardware and software) that a customer or potential customer may use to interface with network 120 and database 110. Network 120 may include, for example, the internet, LAN, WAN, and/or a mobile communications network. Network 120 may be wired or wireless.

Venue owners may connect to network 120 though user end node 140 such as, for example, a mobile phone, a smart phone, a computer, a watch, a tablet, or other communication device. The venue owner may transmit via network 120 various venue owner data and requests. Venue owners may supply database 110 with information on one or more venues

A customer may connect to network 120 though user end node 140 such as, for example, a mobile phone, a smart phone, a computer, a watch, a tablet, or other communication device. The customer may transmit via network 120 various user data and requests.

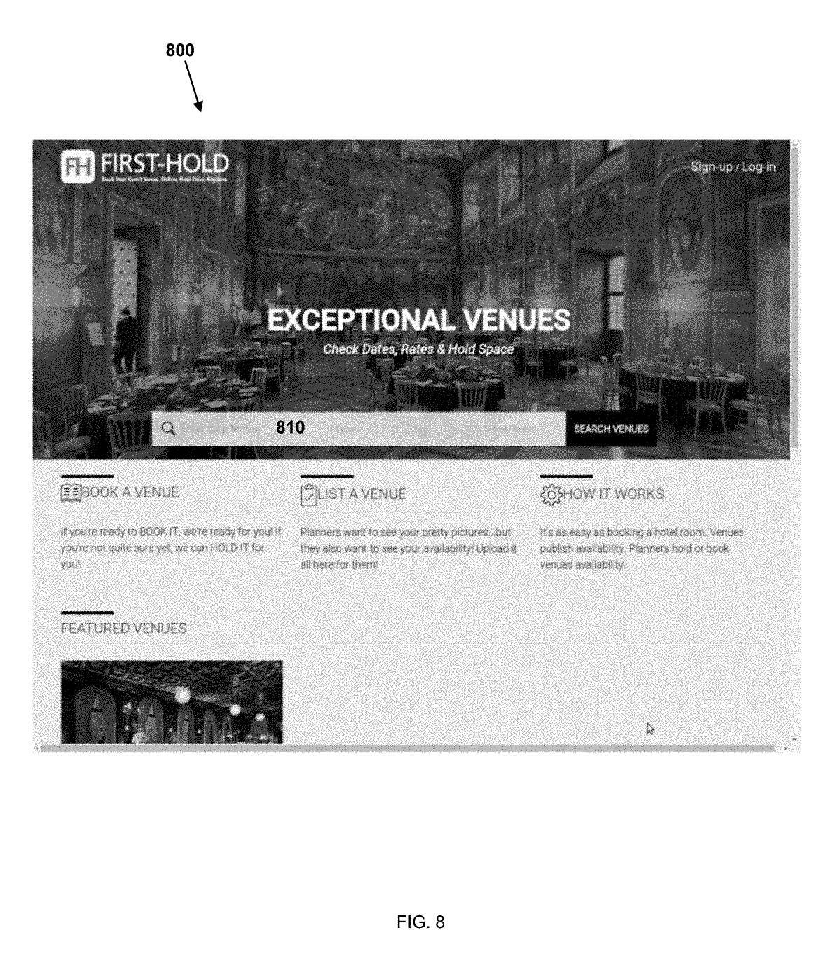

Database 110 may include data on venues, venue owners, and customers. In one embodiment, database 110 may communicate with network 120, user end node 140, and venue space node 130 though, for example, a web interface such as a web page (see for example FIGS. 8-25).

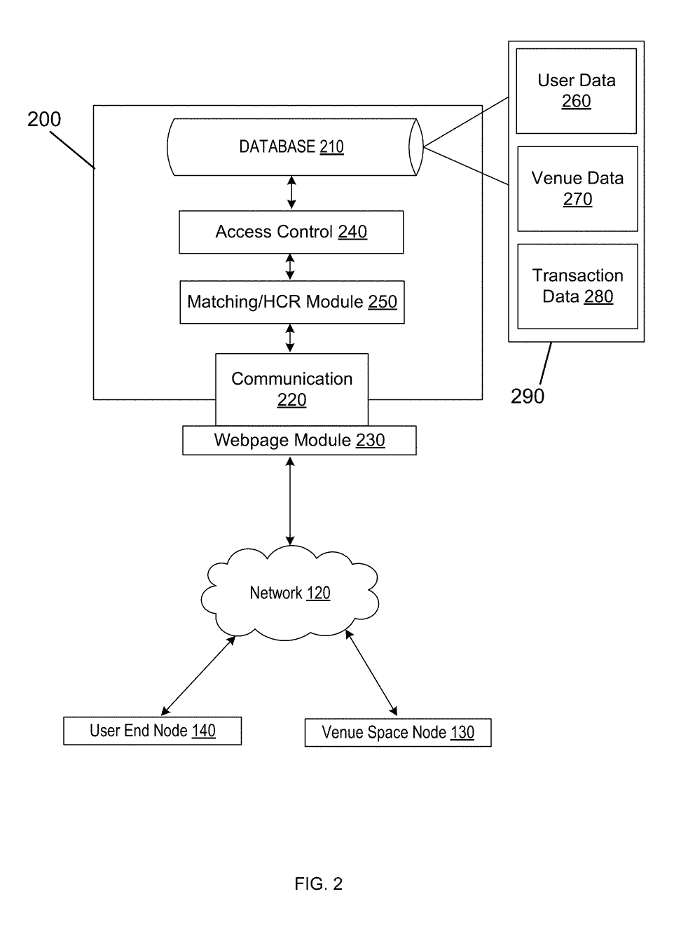

FIG. 2 depicts a block diagram of an embodiment of a database management system 200 corresponding, for example, to the database 110 of FIG. 1. Also shown are network 120, user end node 140, and venue space node 130. As shown, the database management system 200, user end node 140, and venue space node 130 are connected to network 120.

Database management system 200 may include database 210 with data 290. Data 290 may include, at least, user data 260, venue data 270, and transaction data 280. Database management system 200 may include access control 240 configured to selectively allow access to the database 210 by database administrators, venue operators, and customers based on, for example, an access control list. The database management system 200 may also have a communication module 220 configured to send and receive information to and/or from user end node 140 and venue space node 130 via network 120. Further, database management system 200 may also have matching/HCR module 250 designed to match one or more venues to selections from a user end node 140. Matching/HCR module 250 may also provide, for example, the hold, challenge, and release logic. Webpage module 230 may provide a graphical representation of the contents of database 210 and webpage module 230 may be in data communication with communication module 220 and network 120.

User data 260 may include information of the user, such as name, email, phone, address, credit card, etc. Other information may also be included in user data 260.

Venue data 270 may include information on the venue, such as, name, title, description, address, status, etc. Other information may also be included in venue data 270.

Transaction data 280 may include venue information, hall, date of event, price, guests, customer, guest type, booking date, timeslot, etc. Other information may also be included in transaction data 260.

In one embodiment, networked database management system (DBMS) 200 may include a computer accessible data storage which may include database 210 remotely located from a plurality of user nodes (e.g., user end node 140) and a plurality of venue nodes (e.g., venue space node 130). The remote database 210 may include, for example, a plurality of records, such as user node data, venue node data, and transaction data. The DBMS may also include access control module 240 in data communication with the data storage and configured to prevent unauthorized access to database 210, as well as a communication module 220 in data communication with the data storage and configured to receive user node data and venue node data for storage in database 210 and query requests to retrieve user node data and venue node data from database 210. DBMS 200 may also include matching module 250 in communication with the data storage and configured to: compare one or more venue objects to query information received from a first user node, provide one or more venue obj ects to the first user node via the communications module, set a hold on a venue obj ect of the one or more venue objects for the first user node, prohibit assigning the venue object to the first user node if the venue object was held previously by one or more other user nodes, issue a challenge from the first user node to the one or more other user nodes that previously held the venue object, receive an accepted challenge from a second user node of the one or more other user nodes and release the hold on the venue object for the first user node based on the accepted challenge, create a transaction object and assign the venue object to the second user node using the transaction object.

In one embodiment, fields such as the address field for the venue data and user data may be competed using GPS coordinates supplied by venue space node 130 or user end node 140. Other fields may be autocompleted as well.

In another embodiment, a networked system (or a communications device) may be provided where a plurality of end nodes interface with a database. The system may comprise, for example, one or more processors in communication with the database, the database including: (1) one or more user objects, each user object including: a primary key field, a first name field, a last name field, an email field, a phone number field, and an address field; (2) one or more venue objects, each venue object including: a primary key field, a foreign key field, and an address field; and (3) one or more transaction objects, each transaction object including: a primary key field and one or more foreign key fields. The system may also include memory in communication with the one or more processors, the memory containing instructions executable by the one or more processors to: create a plurality of venue objects based on received venue data, the venue data being received by one or more venue nodes of the plurality of end nodes; create a plurality of user objects based on received user data, the user data being received by one or more user nodes of the plurality of end nodes; search the plurality of venue objects based on received location information, date range, and number of attendees from the one or more user nodes and retrieve available venues from the database based on the location information, date range, and number of attendees; provide the available venues to the one or more user nodes; create a first transaction object based on a received first hold request from a first user node for a selected venue on a selected date and place a first hold on the selected venue on the selected date for the first user node; create a second transaction object based on a received second hold request from a second user node for the selected venue on the selected date and place a second hold on the selected venue on the selected date for the second user node; create a third transaction object based on a received third hold request from a third user node for the selected venue on the selected date and place a third hold on the selected venue on the selected date for the third user node; create a challenge request for the third user node to the first user node and the second user node; transmit the challenge request to the first user node and the second user node; receive an accepted challenge from the second user node; release the third hold on the selected venue on the selected date after the accepted challenge by the second user node; transmit a first notice of a release of the third hold to the third user node; release the first hold on the selected venue on the selected date after a period of time from the transmission of the challenge to the first user node; transmit a second notice of a release of the first hold to the first user node; and transmit a notice of acceptance to the second user node after receipt of the accepted challenge and after the period of time from the transmission of the challenge to the first user node. Note that the challenge may be issued after the third user node completes the application requirements (e.g., signs a contract or agreement and pays the booking fee or full venue price). Further, the challenge may be accepted from the second user node after the second user node completes the application requirements (e.g., signs a contract or agreement and pays the booking fee or full venue price).

FIG. 3 illustrates a sample hold-challenge-booking database schema in an embodiment of the invention. Note, FIGS. 3 and 4 display database schemas. Database schema (e.g., FIGS. 3-4) of a database system may be a structure of objects described and supported by the database management system (DBMS) 200. For example, a schema may refer to the organization of data and objects as a blueprint of how the database is constructed (e.g., divided into database tables in the case of relational databases). The schema may show the integrity constraints imposed on a database. These integrity constraints may ensure compatibility between different objects within the schema. A database may be considered a structure in realization of a database language. The schema may describe how real-world entities may be modeled in the database 210.

In particular, FIG. 3 displays three database objects (e.g., tables), a user object, a venue object, and a transaction object, and the relationship between the objects. These objects may be used to allow the database to implement hold, challenge, and assign (or book). The user object may include the following fields, for example: a primary key, a first name, a last name, an email, a phone number, or an address. The venue object may include the following fields, for example: a primary key, a user foreign key, a title, a description, an address, a price, a buyout value, and a status value. The transaction object may include the following fields, for example: a primary key, a user foreign key, a venue foreign key, a hall foreign key, a client value, a guest value, a guest type, a date, a booking date, a timeslot, a status, an amount, a buyout value, and sales contact information. The venue object may be linked to the user object. The transaction object may be lined to both the user object and the venue object.

FIG. 4 depicts another sample database schema in an embodiment of the invention. FIG. 4 displays six database objects (e.g., tables), a user object, a venue object, a transaction object, a timing object, a venue hall object, and a user transaction object, and the relationship between the objects. These objects may be used to allow the database to implement hold, challenge, release, and assign (or book). The user object, venue object, and transaction object may be the same as in FIG. 4. The timing object may include the following fields, for example: a primary key, a venue foreign key, a start time, an end time, a day, and a price. The venue hall object may include the following fields, for example: a primary key, a venue foreign key, a name, a description, an area, a floor, and a column value. The user transaction object may include the following fields, for example: a primary key, a user foreign key, a customer profile, and a customer payment profile. The timing object and the venue hall object may be linked to the venue object. Each venue object may have multiple related venue hall and timing objects. The user transaction object may be linked to the user object. Each user object may have multiple user transaction objects.

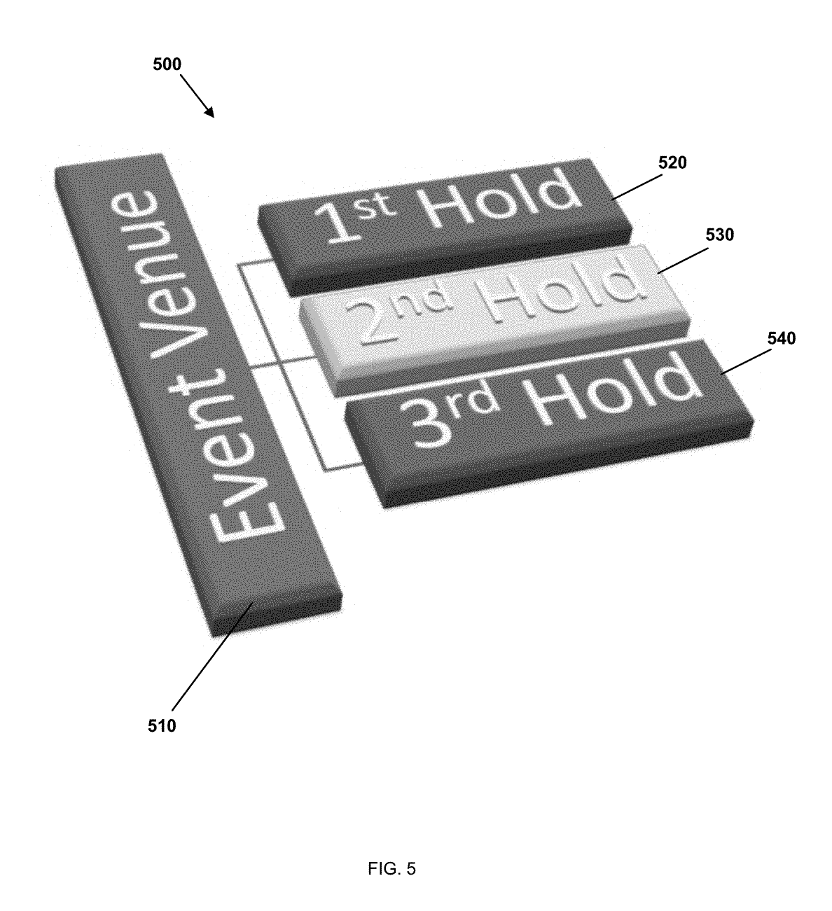

FIG. 5 depicts an example hold, challenge, and release scenario 500. Event venue 510 may advertise availability on particular dates. First visitor 520 may place an initial hold of venue 510 on a particular date (e.g., without signing a contract or paying a deposit). First visitor 520 now has an authorized right of first refusal in the event of another customer query. After first visitor 520 places an initial hold, second visitor 530 requests a second hold of venue 510 on the same date and time. Second visitor 530 may issue a challenge first visitor 520 (e.g., in an embodiment signing a contract and making a deposit may be required). If second visitor 530 does challenge first visitor 520, first visitor 520 has a set period of time (e.g., 24 hours) to accept and complete the challenge (e.g., in some embodiments to sign a contract and pay a deposit). If second visitor 530 does not challenge, second visitor 530 has a second right of refusal. After second visitor 530 places the second hold, third visitor 540 may request a third hold of venue 510 on the same date and time. Third visitor 540 may issue a challenge to second visitor 530 and first visitor 520 (e.g., in some embodiments signing a contract and making a deposit may be required). If third visitor 540 does challenge second visitor 530 and first visitor 520, second visitor 530 and first visitor 520 have a set period of time (e.g., 24 hours) to accept the challenge (e.g., in some embodiments to sign a contract and pay a deposit). First visitor 520 or second visitor 530 may release their hold on event 510. If third visitor 540 issues a challenge and the set period of time elapses and neither first visitor 520 nor second visitor 530 has accepted the challenge (e.g., signed a contract and paid a deposit), third visitor 540 may receive event 510. Once a challenge is issued, the event 510 will be awarded to the visitor that accepts the challenge (e.g., signs the contract and pays the deposit in the order of the placed holds).

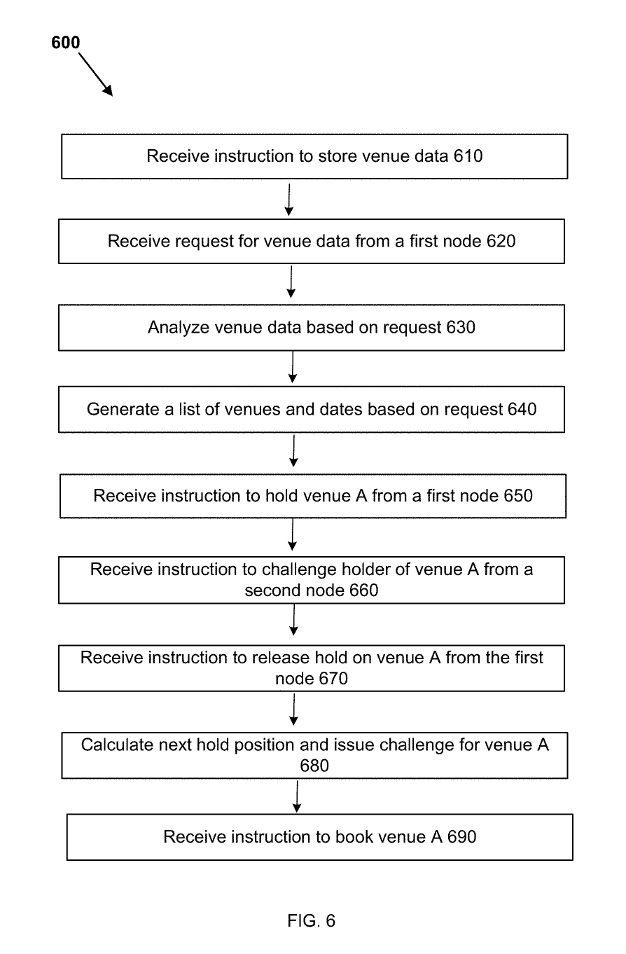

FIG. 6 depicts an example workflow in an embodiment of the invention. Flow may start in 610. In 610, instructions may be received by, for example, DBMS 200 from venue space node 130 (e.g., venue node), to store venue data. From 610, flow may move to 620. In 620, a request may be received by, for example, DBMS 200 from user end node 120 (e.g., user node), for venue data. From 620, flow may move to 630. In 630, the venue data 260 stored in database 210 may be analyzed based on the request. From 630 flow may move to 640. In 640, DBMS 200 may generate a list of matching available venues and dates that correspond to the request from user end node 120. From 640, flow may move to 650. In 650, DBMS 200 may receive a request to hold a venue A, for example, from a first user end node 120. From 650, flow may move to 660. In 660, DBMS 200 may receive request to challenge the hold of venue A from a second user end node 120. The hold may be challenged by the second user completing the application requirements, for example. From 660, flow may move to 670. In 670, the DBMS 200 may release the hold on venue A from the first user end node. The hold may be released based on an instruction to release the hold issued by the first user node or by a lack of response from the first user node within a specified period of time (e.g., 24 hours). From 670 flow may move to 680. In 680, DBMS 200 may calculate the next hold position and issue another challenge for a hold to venue A. Alternatively, all challenges may be made in with the initial challenge. If challenges are made within the initial challenge, any end user nodes accepting the challenge will be accepted in, for example, chronological order of placing the hold, with the oldest hold having the highest priority. From 680, flow may move to 690 and venue A is booked and no longer available to be held. Flow may end after 680.

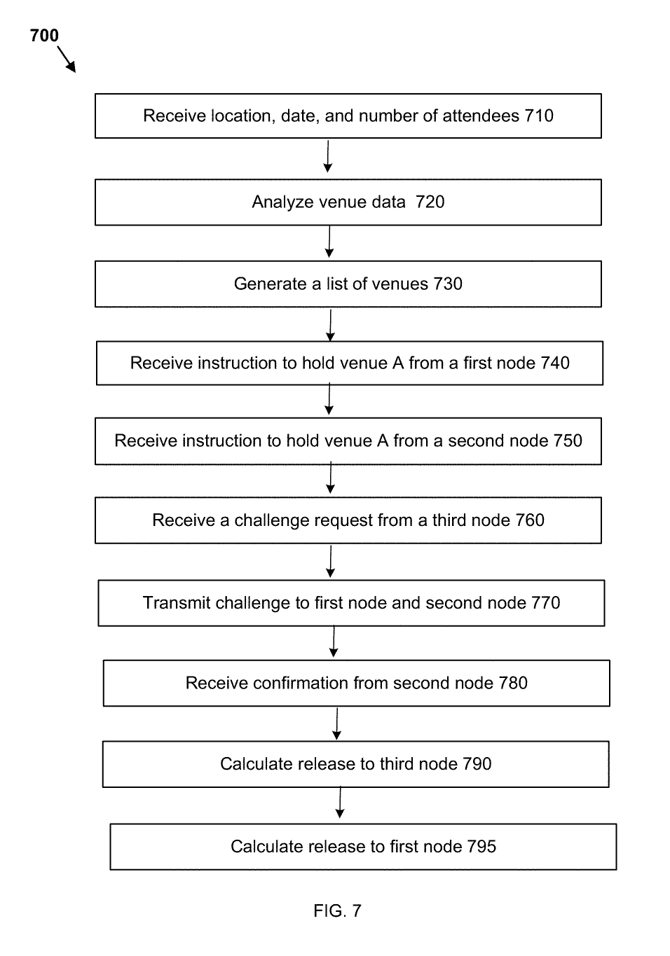

FIG. 7 depicts another example workflow in an embodiment of the invention. Flow may start in 710. In 710, DBMS 200, for example, may receive data such as location, date, and number of attendees from, for example, a user end node 120. From 710, flow may move to 720. In 720, DBMS 200, for example, may analyze venue data stored in database 210. From 720, flow may move to 730. In 730, DBMS 200, for example, may generate a list of potential venues based on the analyzed venue data and the location, date, and number of attendees. From 730, flow may move to 740. In 740, a first user end node may provide DBMS 200, for example, an instruction to hold venue A. From 740, flow may move to 750. In 750, a second user end node may provide DBMS 200, for example, an instruction to hold venue A. From 750, flow may move to 760. In 760, a third user end node may provide DBMS 200, for example, a challenge request for venue A. From 760, flow may move to 770. In 770, DBMS 200, for example, may issue the challenge to first node and second node. From 770, flow may move to 780. In 780, confirmation may be received from the second node. The second node may accept the challenge and affirm the hold (e.g., book) venue A. From 780, flow may move to 790. In 790, DBMS 200, for example, releases the third node from venue A based on the second node acceptance of the challenge. From 790, flow may move to 795. In 795, DBMS 200, for example, releases the first node from venue A based on the second node acceptance of the challenge and on an elapsed period of time in which the first node did not accept the challenge.

FIG. 8 is a sample screen shot of home page 800. Home page 800 includes entry field 810 that provides for entering a city (e.g., area or city and state), dates, and number of people. Once this information is entered, a database lookup is performed to retrieve available venues for that area, dates, and number of people. Filters may be provided to filter by price, city, keyword, and/or flexible dates. Search results may also be able to be sorted by recommended, low to high price, and/or high to low price. Multiple views may be provided, such as list view, photo view, and/or map view. Additional details on the venue may be provided such as venue name and title, reviews and ratings, price, venue information, and/or property address. Additional actions may be taken such as marking the venue as a favorite or looking up the property location in a map. Venue details may include, photo(s), booking availability calendar, street view(s), description(s), amenities, contact information, venue reviews, and/or favorite.

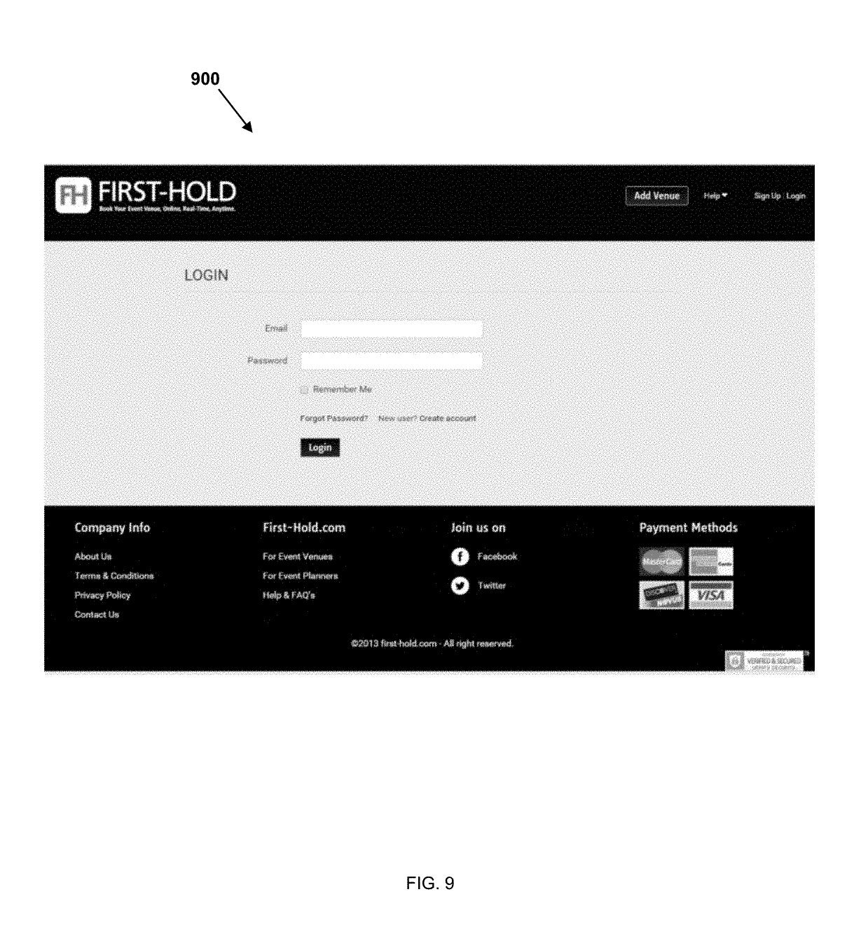

In another embodiment, a customer dashboard may be provided. FIG. 9 is a sample screen shot of login page 900 that may provide access to, for example, a customer dashboard.

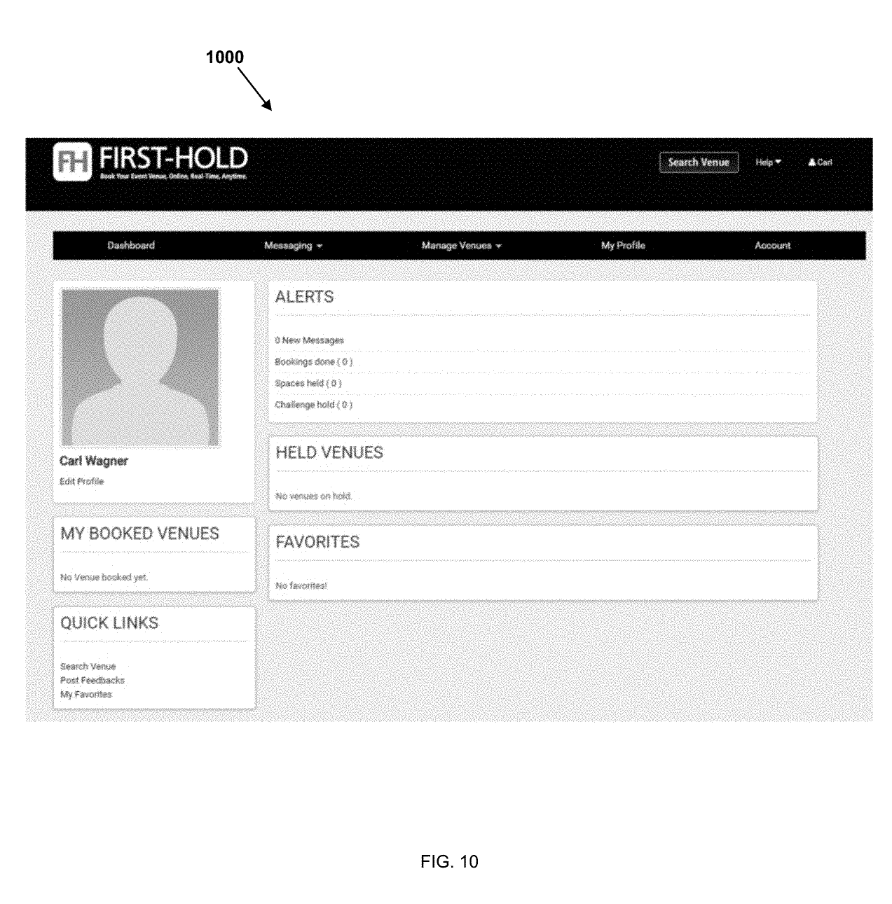

FIG. 10 is a sample screen shot of customer dashboard 1000. Customer dashboard 1000 may have the following example features: login/registration, new message alert, quick links, booked spaces, spaces on hold, feedback, post feedback, favorites, inbox, sent messages, all messages, deleted messages, account details, change password, and/or create/update profile.

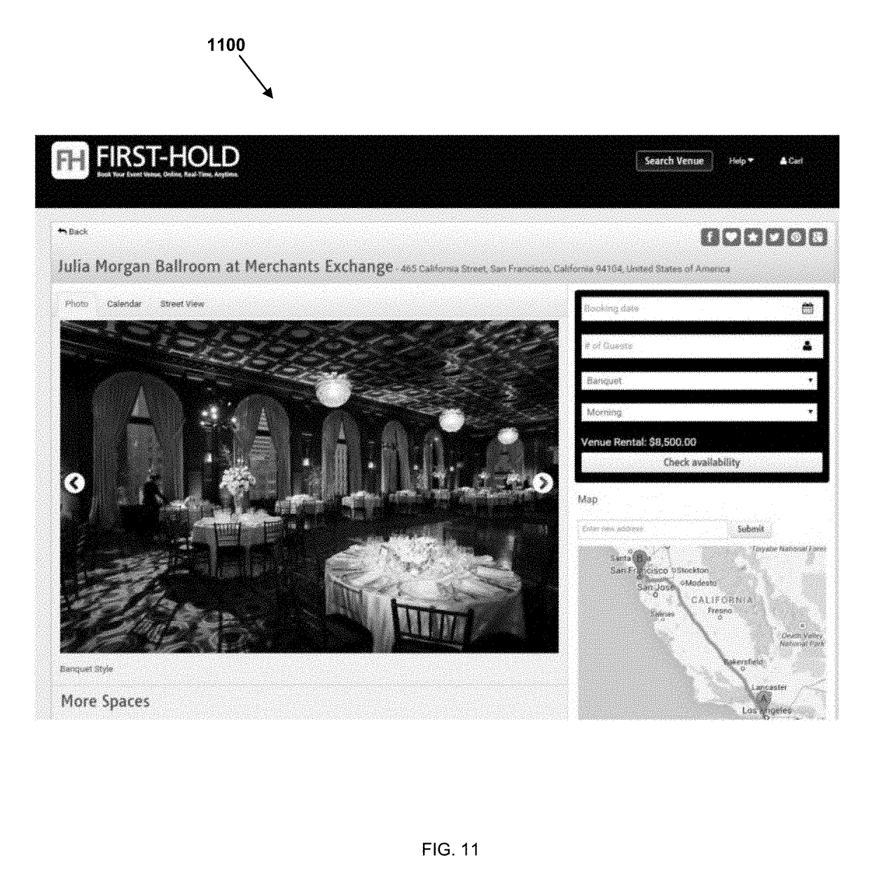

FIG. 11 is a sample screen shot of a search result page 1100. Search result page 1100 shows, for example, a result of a database lookup for a given area, between select dates, and for a select number of people.

Search result page 1100 may provide, for example, a list of available venues, dates (e.g., calendar) and pricing for venues in a particular area. Search result page 1100 may be based on search criteria, for example, a selection of city, date range, number of people.

When viewing details of a particular venue, a user may see, for example, the cost of booking a venue on a particular date, and the number of people it can accommodate in various modes, such as, seated, outdoor, buffet, etc. Also, the user can see the terms and conditions of the venue owner for holding an event at his venue.

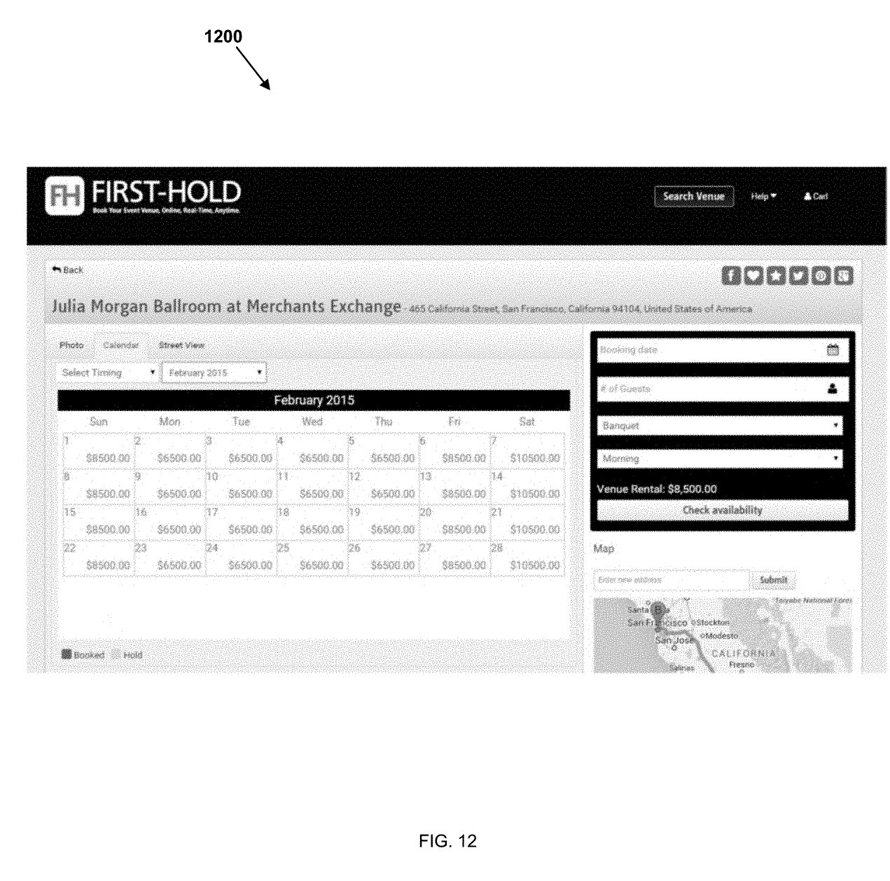

FIG. 12 is a sample screen shot of availability calendar 1200. When viewing a venue, a customer may select, for example, a calendar tab to display the venue's availability and cost on a particular date.

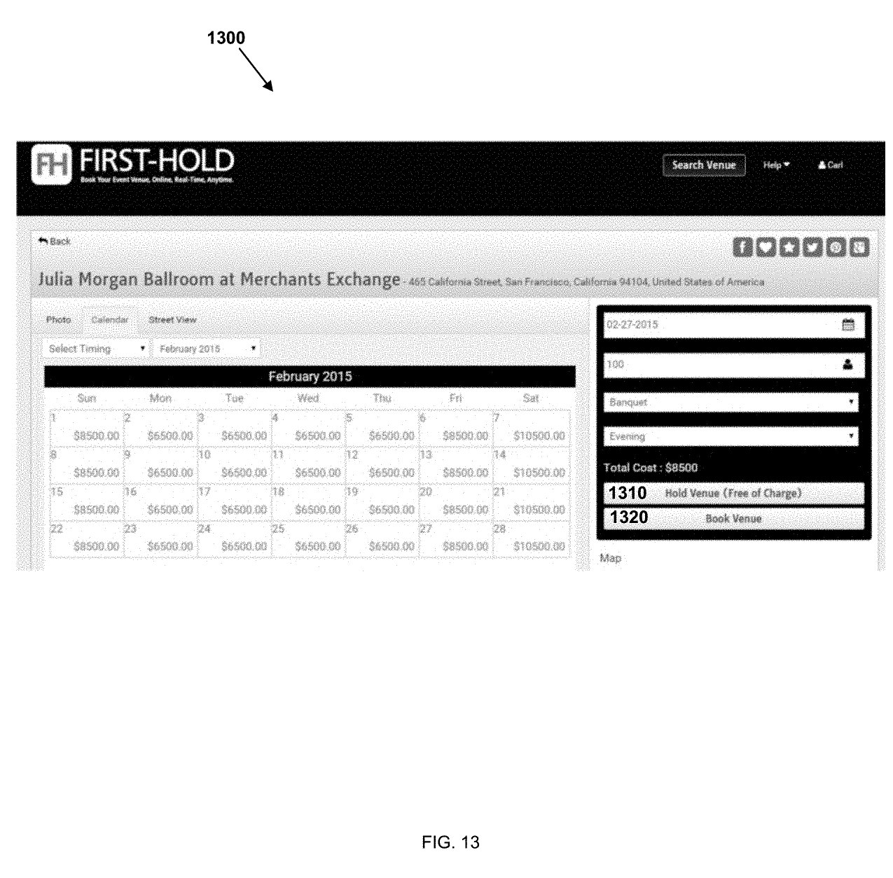

FIG. 13 is a sample screen shot of a customer dashboard 1300 for holding or booking a venue. Customer dashboard 1300 may have hold venue option 1310 and book venue option 1320. A customer may hold a venue on a selected date by, for example, selecting the hold venue option 1310. A hold does not have the finality of booking the venue on the selected date and gives the customer the option to book the venue without having to execute a contact or place a deposit. This gives the customer flexibility to choose the best venue for his/her event before finally expressing interest to the owner to book it.

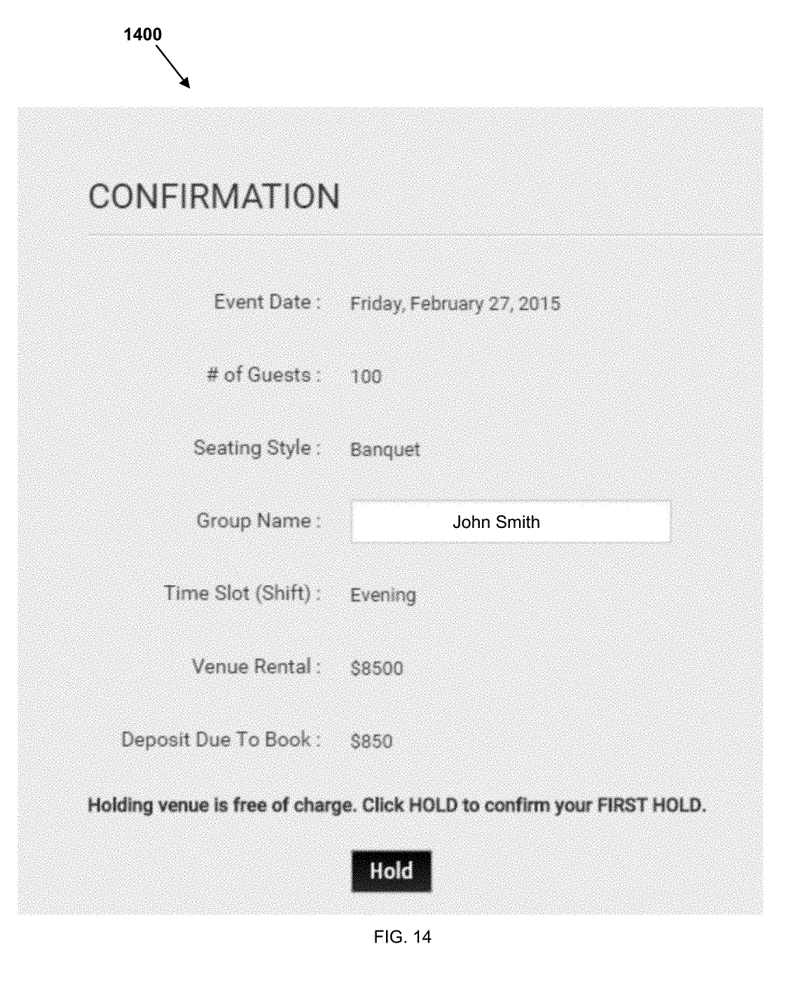

FIG. 14 depicts sample confirmation screen 1400. Confirmation screen 1400 shows the event details such as, for example, date, number of guests, seating style, group name, time, cost, and deposit amount. Customer may place a hold and may receive a hold confirmation message and/or a message in the customer's inbox with details on, for example, the venue name, date held, contact name, and venue phone number.

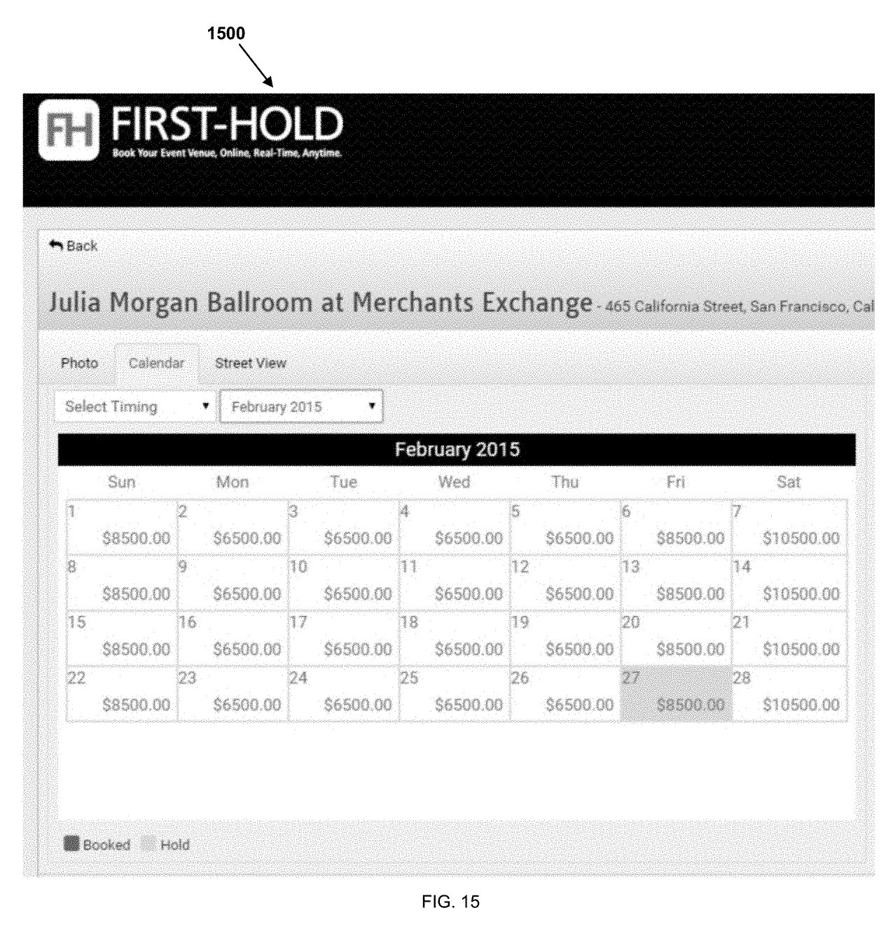

FIG. 15 is a sample screen shot of availability calendar 1200 after a hold is placed. FIG. 15 shows that after a hold was placed, availability calendar 1200 now depicts a date as being held.

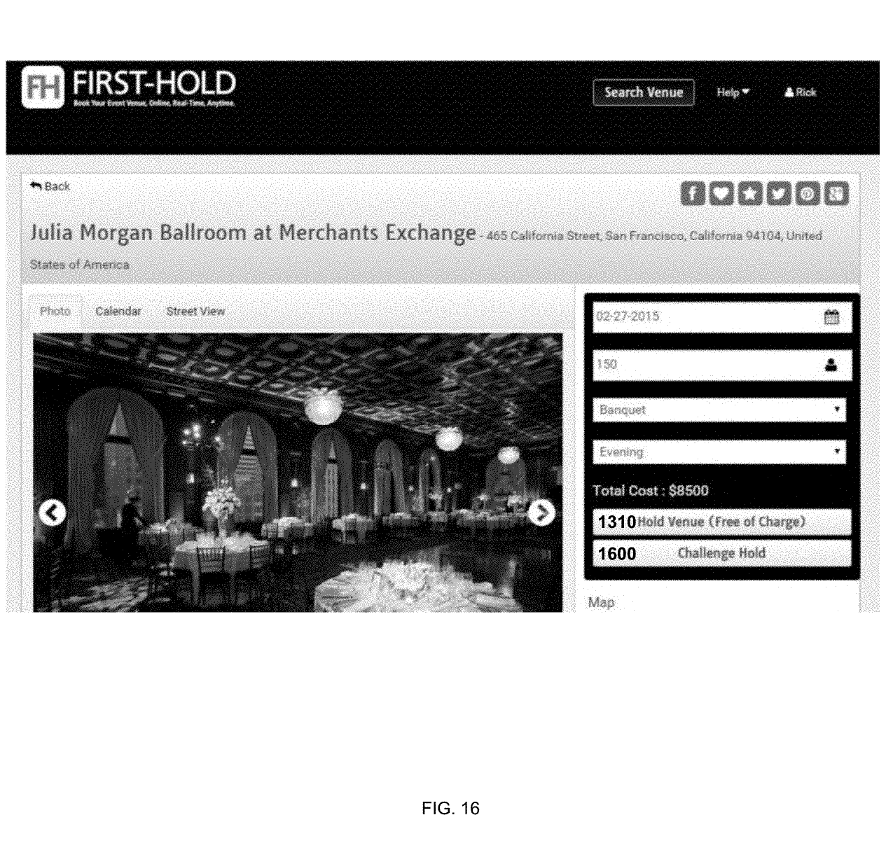

FIG. 16 is a sample screen shot showing challenge hold option 1600. The challenge hold option 1600 may appear when a second or subsequent customer or visitor, for example, views information of a venue on a date that has been held by a previous customer. A second or subsequent customer or visitor may also select hold venue option 1310, and has the option to place a second hold on the event at the selected date and time. Should the second or subsequent customer or visitor select the challenge hold option 1600, the second or subsequent customer or visitor must provide payment information (e.g., credit card) and provide a deposit and/or execute a contract to challenge the previous hold. The second or subsequent customer or visitor must also wait a specified period of time (e.g., 24 hours) to, for example, give the customers that issued a previous hold time to execute a contract and/or pay a deposit.

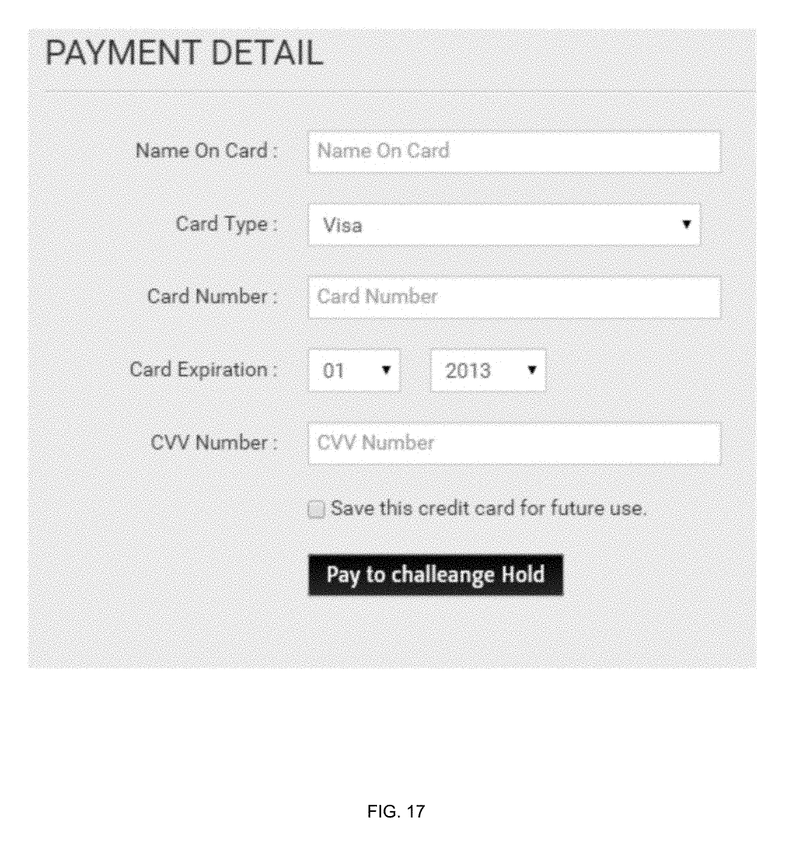

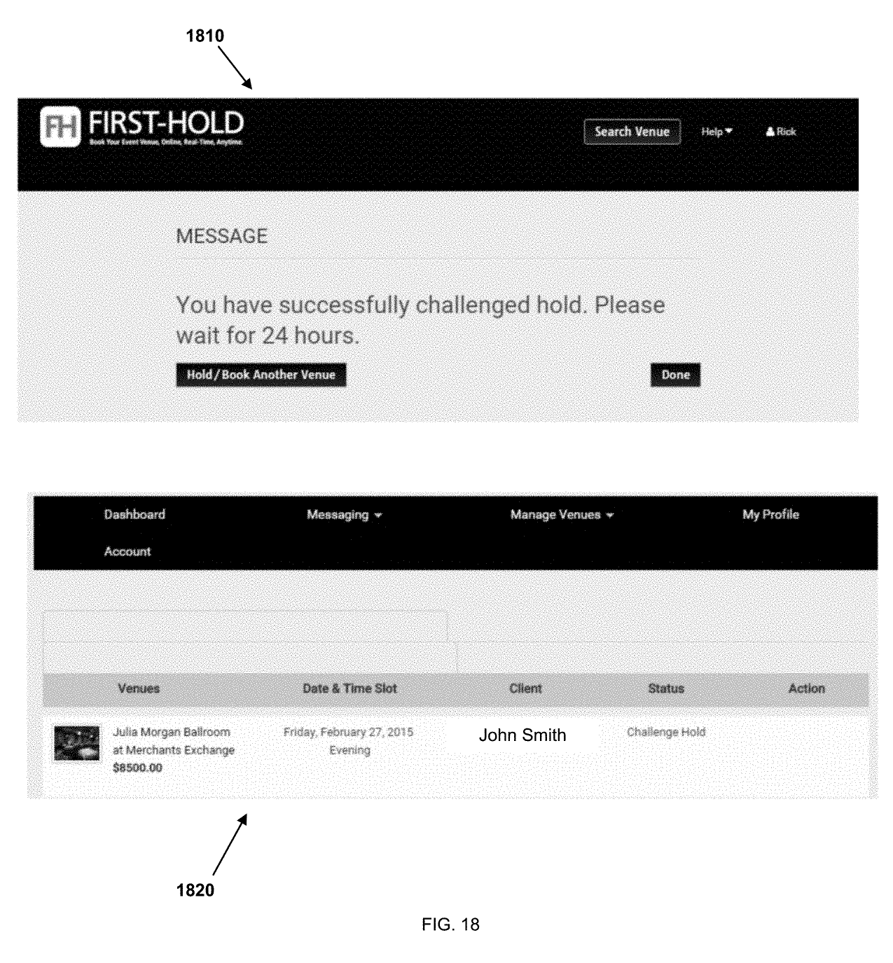

FIG. 17 depicts a sample screen shot for entering credit card information and paying a deposit. FIG. 18 depicts a sample screen shots showing a message when a hold has been successfully challenged (e.g., customer has issued challenge, paid a deposit, and/or executed a contract) 1810 and details of the issued challenge from a customer dashboard 1820.

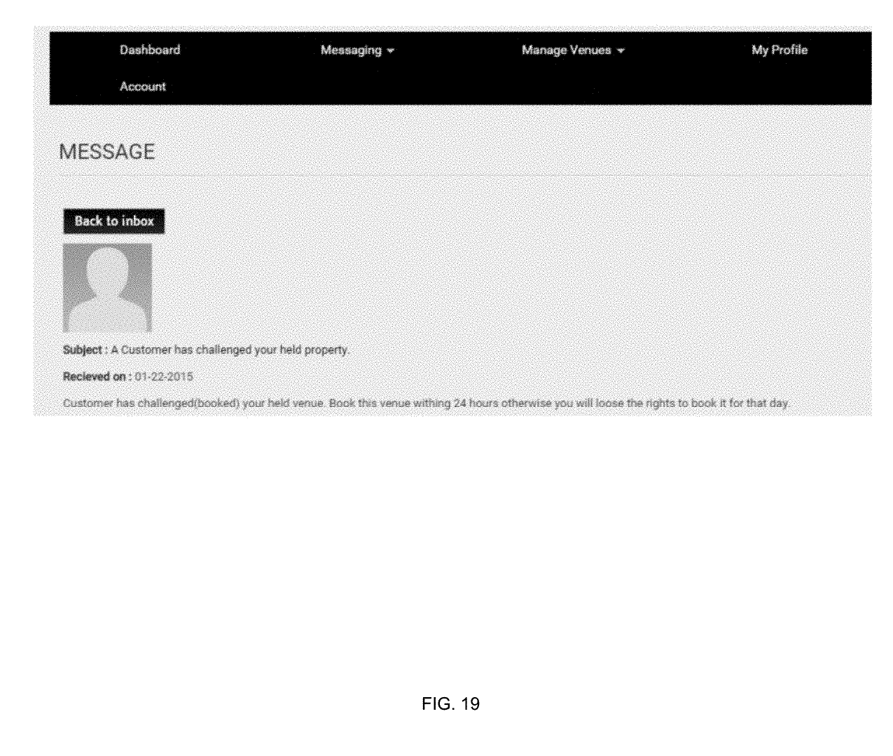

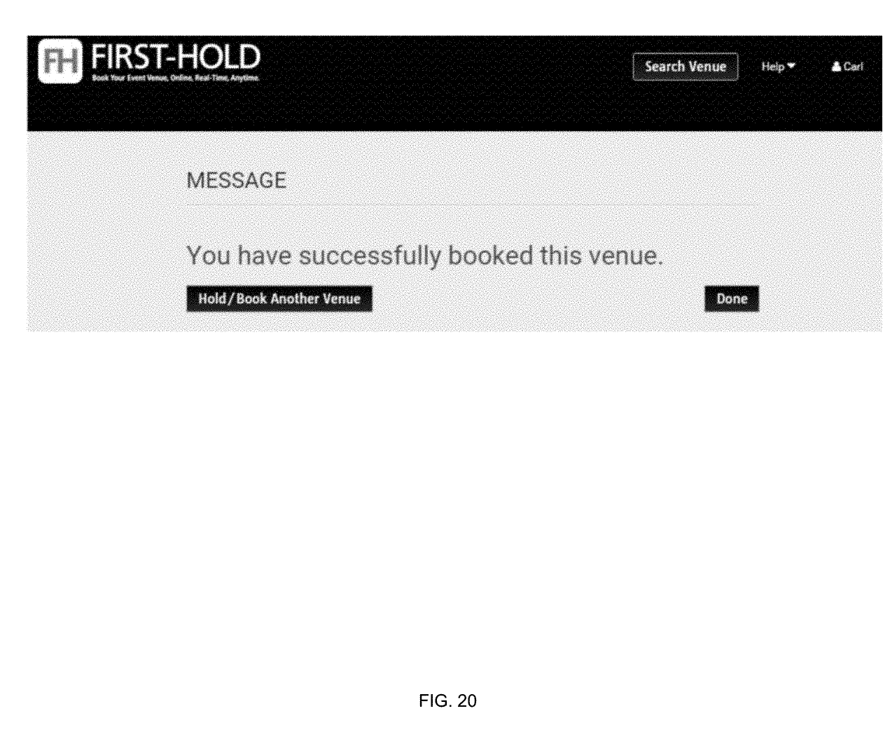

In one embodiment, after a challenge, the customers that previously issued a hold request will receive notification that they have a specified period of time (e.g., 24 hours) to book the venue (e.g., pay a deposit and/or execute a contract). FIG. 19 depicts a sample screen shot informing a customer that a held venue is being challenged. The customer being challenged now has the option to book the venue. If the customer being challenged does not book the venue in the specified period of time, booking of the venue will go to the challenger. Once the venue is booked, the venue is no longer available on that date and/or time. FIG. 20 depicts a sample screen shot informing a customer that the venue was successfully booked.

Any number of holds may be placed on a venue at a date and time. Some embodiments of the invention may limit the number of holds to a maximum of three, for example. The order of the placement of the holds may determine the priority. For example, the second hold has priority over the third hold. So, the second hold will have the right to book the venue at the selected date and time before the third hold. In the current state of the art, instantaneous or near real-time, at least three-way communication between the customers vying for the event space and event management was not possible. For example, direct three-way communication, during regular business hours, had to take place between the vying customers through an event venue manager. With an embodiment of the invention described herein, this process can now happen in the marketplace at any time of day, and on an instantaneous basis, where before this was not possible.

A venue owner dashboard may also be provided. The venue owner may log on similar to FIG. 9. The venue owner dashboard may have the following features: login, new booking alert, new hold spaces alert, new message alert, quick links, manage venues, add new venue, publish and/or unpublished venues, manage venue calendars, venue bookings, accept/reject customer feedback, inbox, sent messages, all messages, deleted messages, account details, change password, opt-in email alerts for hold space, and/or create/update profile.

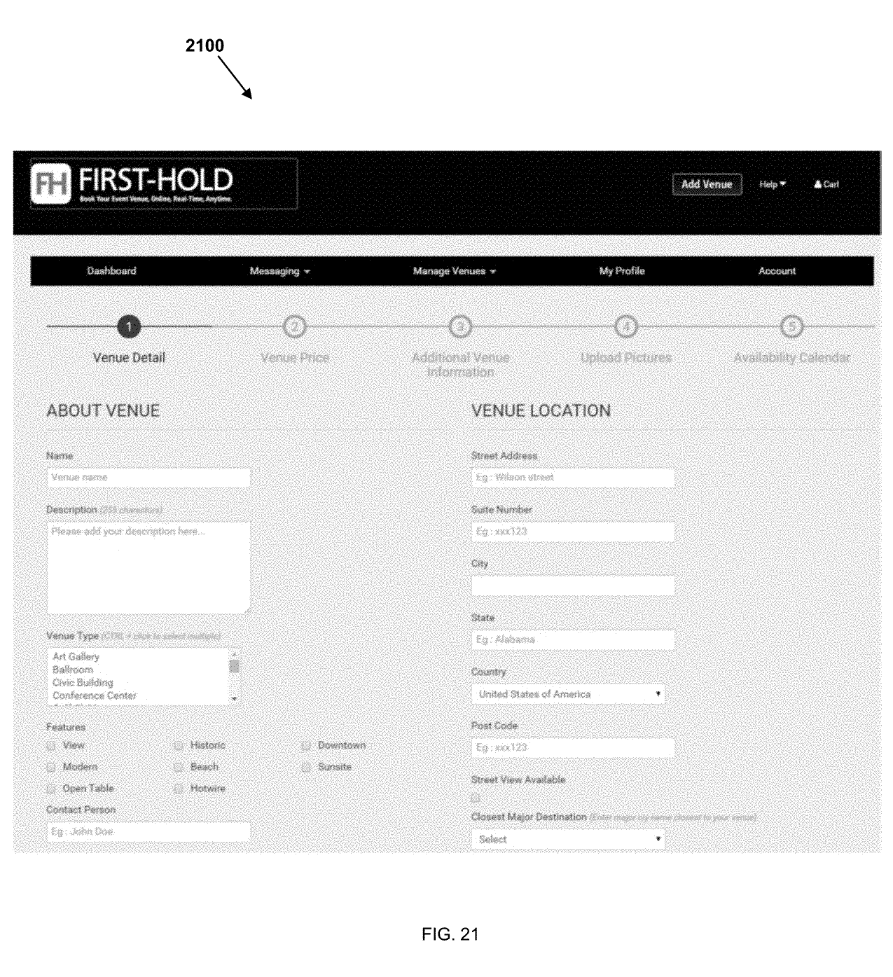

FIG. 21 depicts sample screen shot 2100 to add venue details. Venue detail information may include name, description, venue type, various features (view, modern, downtown, beach, historic, etc.), address, contact person, street view, closest landmark, etc.

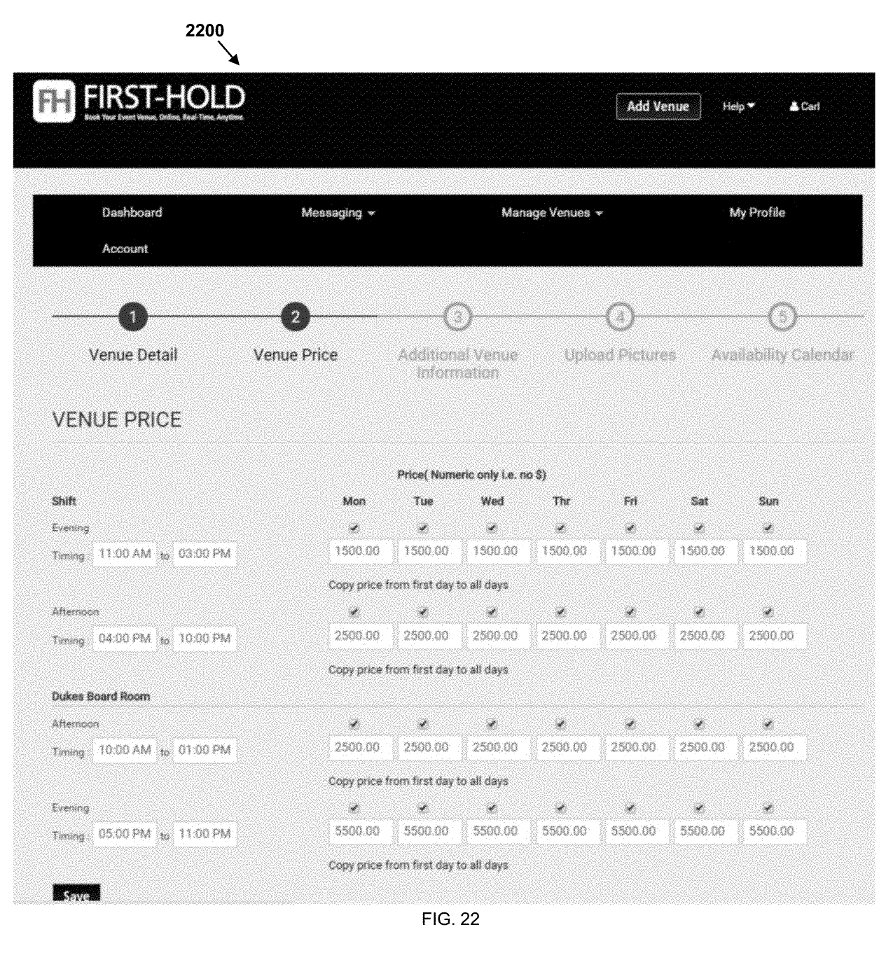

FIG. 22 depicts sample screen shot 2200 to add venue pricing. Venue owners may have the flexibility to input pricing for individual dates. For example, venue owners may charge higher rates during holidays or peak seasons. Venue owners may also have the flexibility to input pricing for various times of day. Venue owners may also display the dates on which the venue is not available due, for example, to some prior bookings or maintenance at the venue.

An embodiment of the invention may provide revenue management for venues by allowing venue owners to generate/increase revenue (e.g., once a date is lost because a venue was not booked, it is lost time and lost money) and allows venue owners to change rates due to market pressure and/or weakness for optimal sales and/or revenue. Venue owners may have the ability to enter different rates for various dates based on the market pressure and/or demand. Venue owners may synchronize the bookings of their single or multiple venues via a single platform. Currently, venues typically publish their venue rental rates at the beginning of the year. Due to inefficiencies in the marketplace, obligations to vendors, preexisting rental quotes, etc. it is prohibitive and imprudent for a venue to modify these published rates. An embodiment of the invention described herein provides a platform from which a venue manager may modify pricing instantly, in real time, with no disruption or disorder to the marketplace. Subsequently and immediately, for example, any potential customer visiting the availability calendar will see this updated price. Venue's changing prices and customers receiving updates in real time was not possible until now.

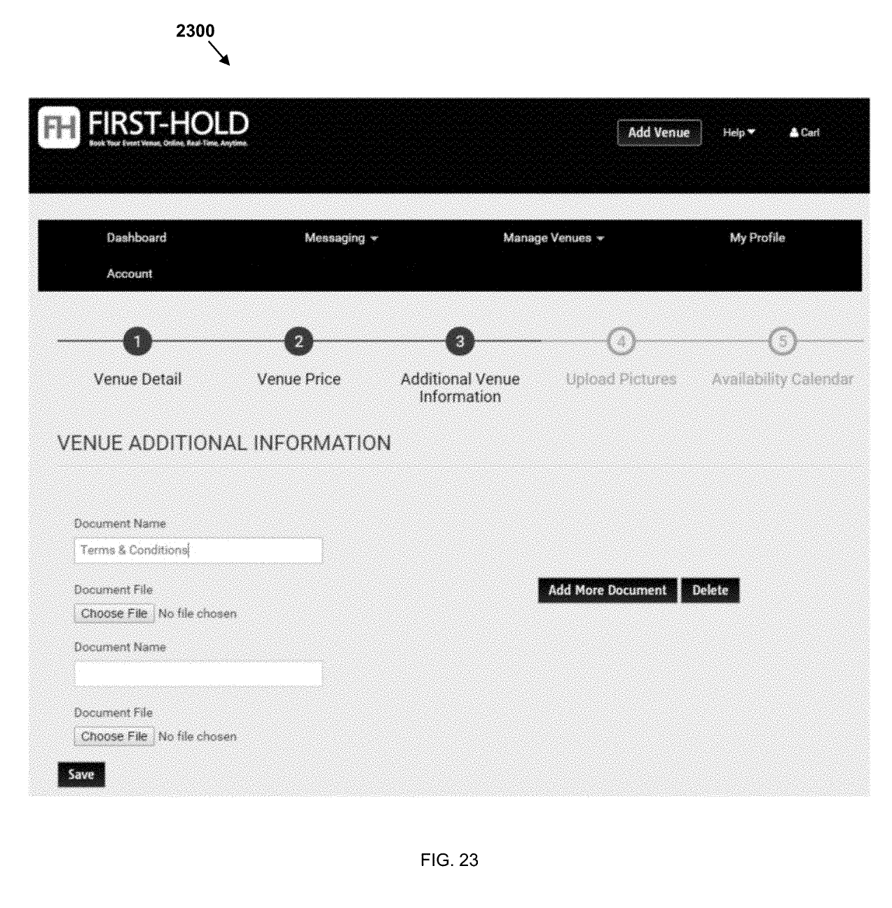

FIG. 23 depicts sample screen shot 2300 to add additional venue information. Additional venue information may include, for example, terms and conditions or other documents.

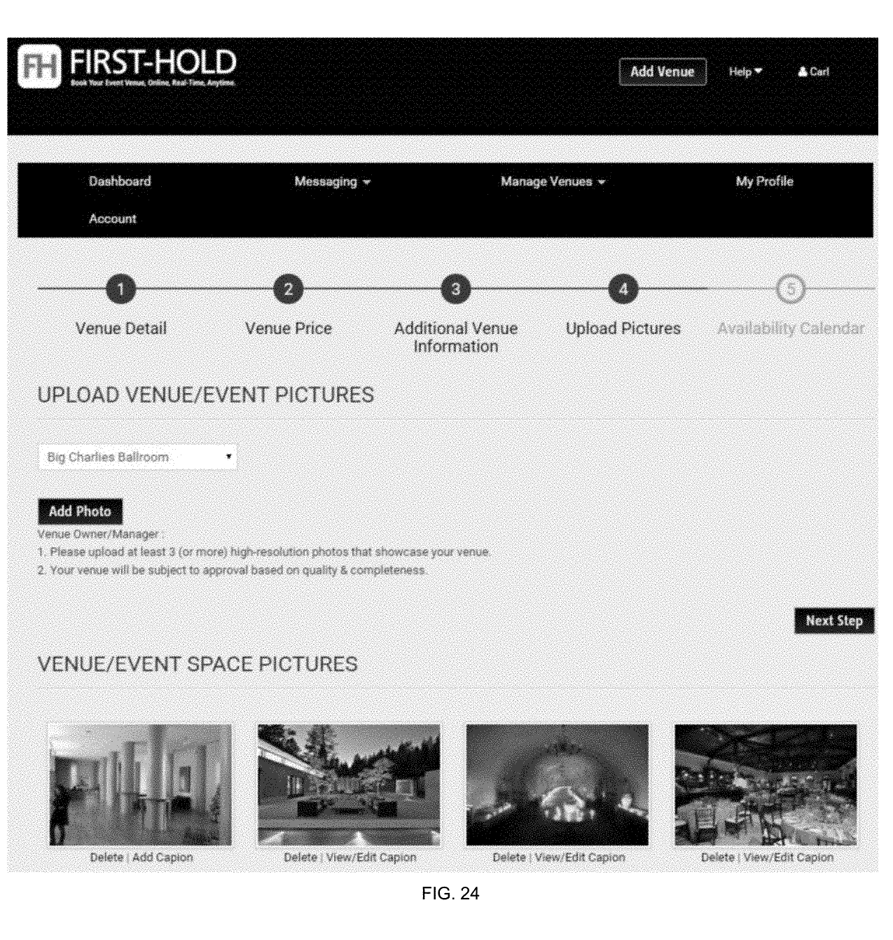

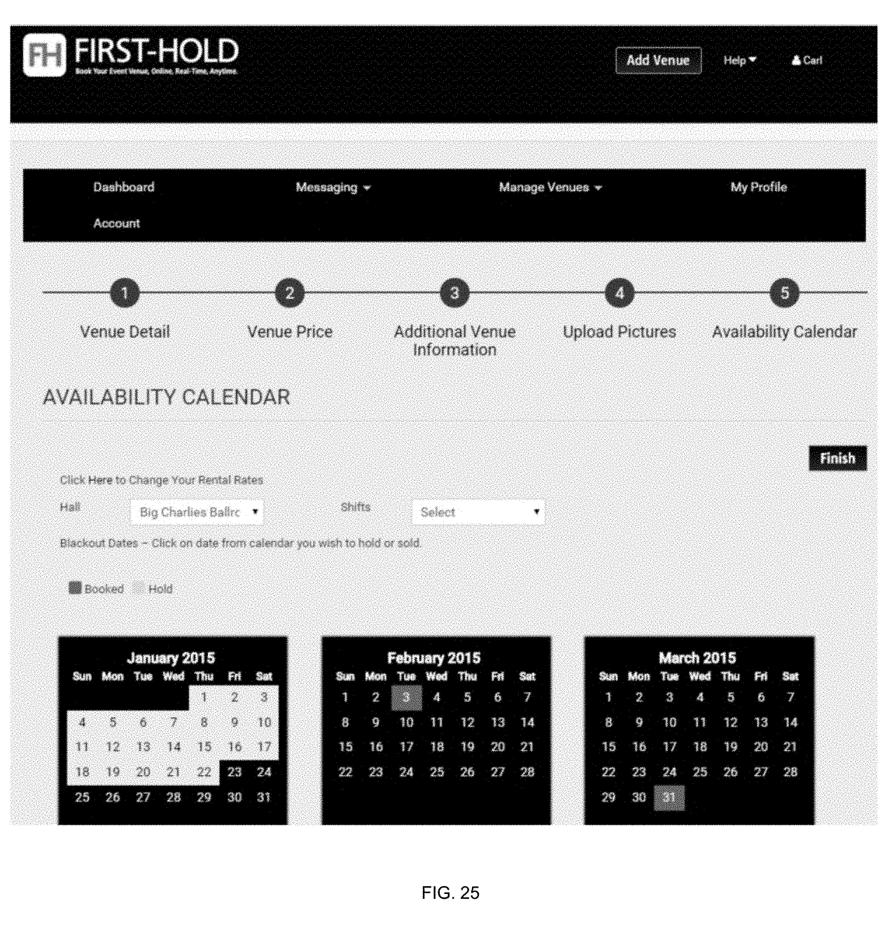

FIG. 24 depicts a sample screen shot to add venue photographs. FIG. 25 depicts a sample screen shot to add venue availability information.

Some venues may have multiple halls that may be combined for a large event or used singularly for multiple small events, or in some combination. In an embodiment of the invention, venues with multiple halls may be prioritized to maximize the venue owner profit. A master venue may receive priority in terms of listing on the system. Additional sub venues and/or halls may be visible to customers or visitors. For example, sub venues and/or halls may be visible from the drop down box on the master venue page. When a sub venue and/or hall is chosen, additional details may be provided such as images, price, and availability of that respective sub venue and/or hall. In an embodiment of the invention, venue owner profit may be maximized in the scenario when multiple customers are vying for multiple different combinations of a configurable venue. Alternatively, in another embodiment, the number of customers may be maximized. Embodiments may allow venue owners/managers to designate/allocate the appropriate spacing combinations when creating their venue. Venue owners may select which combinations of various event spaces may be available and are configurable with each other, and in what order their space has to be sold. For example, ballrooms A and B may be booked, but you cannot only book ballroom B because ballroom A will then not be available due to an adjacent location. However, ballroom A may be booked by itself, because B has another entry point, for example. Thus, ballroom A must be booked before or with ballroom B. When ballroom A is booked, ballroom B may still be on the marketplace for rent. Accordingly, in an embodiment, ballroom A may have priority over ballroom B, but the combination of ballrooms A and B may have priority over a booking of ballroom A.

Illustrative Computer System

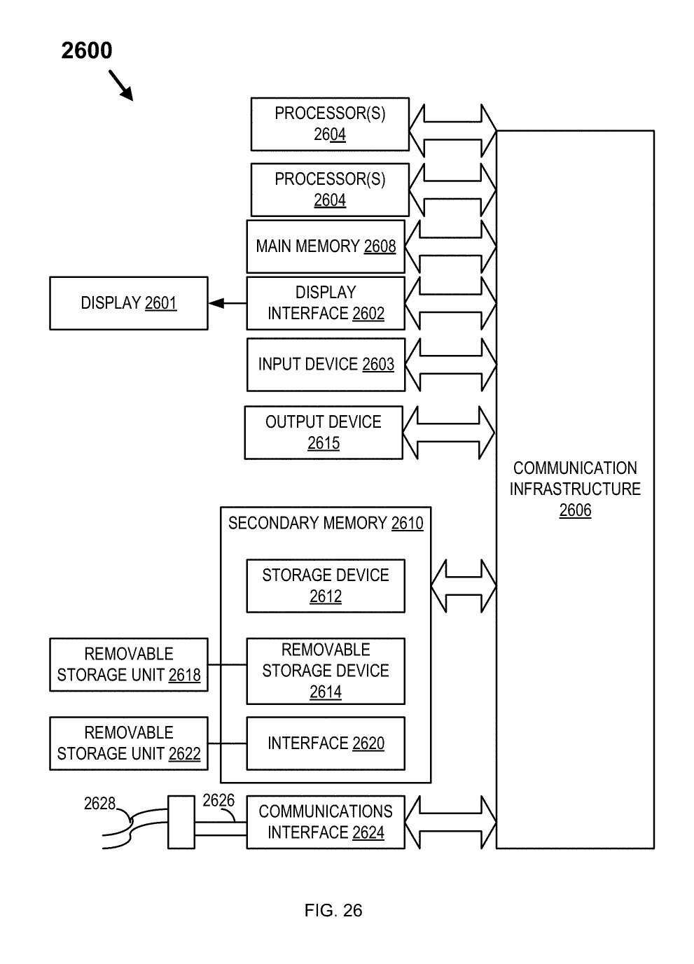

FIG. 26 depicts an illustrative computer system that may be used in implementing an illustrative embodiment of the present invention. Specifically, FIG. 26 depicts an illustrative embodiment of a computer system 2600 that may be used in computing devices such as, e.g., but not limited to, standalone or client or server devices. FIG. 26 depicts an illustrative embodiment of a computer system that may be used as client device, or a server device, etc. The present invention (or any part(s) or function(s) thereof) may be implemented using hardware, software, firmware, or a combination thereof and may be implemented in one or more computer systems or other processing systems. In fact, in one illustrative embodiment, the invention may be directed toward one or more computer systems capable of carrying out the functionality described herein. An example of a computer system 2600 is shown in FIG. 26, depicting an illustrative embodiment of a block diagram of an illustrative computer system useful for implementing the present invention. Specifically, FIG. 26 illustrates an example computer 2600, which in an illustrative embodiment may be, e.g., (but not limited to) a personal computer (PC) system running an operating system such as, e.g., (but not limited to) MICROSOFT® WINDOWS® NT/98/2000/XP/Vista/Windows 7, 8, 10, etc. available from MICROSOFT® Corporation of Redmond, Wash., U.S.A. or an Apple computer or tablet executing MAC® OS, OS X, or iOS from Apple® of Cupertino, Calif., U.S.A., or a computer running a Linux or other UNIX derivative. However, the invention is not limited to these platforms. Instead, the invention may be implemented on any appropriate computer system running any appropriate operating system. In one illustrative embodiment, the present invention may be implemented on a computer system operating as discussed herein. An illustrative computer system, computer 2600 is shown in FIG. 26. Other components of the invention, such as, e.g., (but not limited to) a computing device, a communications device, a telephone, a personal digital assistant (PDA), an iPhone, an iPad, a Surface, and Android device, a 3G/4G wireless device, an LTE device, a wireless device, a personal computer (PC), a handheld PC, a laptop computer, a smart phone, a mobile device, a netbook, a handheld device, a portable device, an interactive television device (iTV), a digital video recorder (DVR), client workstations, thin clients, thick clients, fat clients, proxy servers, network communication servers, remote access devices, client computers, server computers, peer-to-peer devices, routers, web servers, data, media, audio, video, telephony or streaming technology servers, etc., may also be implemented using a computer such as that shown in FIG. 26. In an illustrative embodiment, services may be provided on demand using, e.g., an interactive television device (iTV), a video on demand system (VOD), via a digital video recorder (DVR), and/or other on demand viewing system. Computer system 2600 and/or parts of computer system 2600 may be used to implement the network, processing device, components, and/or interface as described in FIGS. 1-5 and 8-15.

The computer system 2600 may include one or more processors, such as, e.g., but not limited to, processor(s) 2604. The processor(s) 2604 may be connected to a communication infrastructure 2606 (e.g., but not limited to, a communications bus, cross-over bar, interconnect, or network, etc.). Processor 2604 may include any type of processor, microprocessor, or processing logic that may interpret and execute instructions (e.g., for example, a field programmable gate array (FPGA)). Processor 2604 may comprise a single device (e.g., for example, a single core) and/or a group of devices (e.g., multi-core). The processor 2604 may include logic configured to execute computer-executable instructions configured to implement one or more embodiments. The instructions may reside in main memory 2608 or secondary memory 2610. Processors 2604 may also include multiple independent cores, such as a dual-core processor or a multi-core processor. Processors 2604 may also include one or more graphics processing units (GPU) which may be in the form of a dedicated graphics card, an integrated graphics solution, and/or a hybrid graphics solution. Various illustrative software embodiments may be described in terms of this illustrative computer system. After reading this description, it will become apparent to a person skilled in the relevant art(s) how to implement the invention using other computer systems and/or architectures.

Computer system 2600 may include a display interface 2602 that may forward, e.g., but not limited to, graphics, text, and other data, etc., from the communication infrastructure 2606 (or from a frame buffer, etc., not shown) for display on the display unit 2601. The display unit 2601 may be, for example, a television, a computer monitor, iPad, a mobile phone screen, etc. The output may also be provided as sound through, for example, a speaker.

The computer system 2600 may also include, e.g., but is not limited to, a main memory 2608, random access memory (RAM), and a secondary memory 2610, etc. Main memory 2608, random access memory (RAM), and a secondary memory 2610, etc., may be a computer-readable medium that may be configured to store instructions configured to implement one or more embodiments and may comprise a random-access memory (RAM) that may include RAM devices, such as Dynamic RAM (DRAM) devices, flash memory devices, Static RAM (SRAM) devices, etc.

The secondary memory 2610 may include, for example, (but is not limited to) a hard disk drive 2612 and/or a removable storage drive 2614, representing a floppy diskette drive, a magnetic tape drive, an optical disk drive, a compact disk drive CD-ROM, flash memory, etc. The removable storage drive 2614 may, e.g., but is not limited to, read from and/or write to a removable storage unit 2618 in a well-known manner. Removable storage unit 2618, also called a program storage device or a computer program product, may represent, e.g., but is not limited to, a floppy disk, magnetic tape, optical disk, compact disk, etc. which may be read from and written to removable storage drive 2614. As will be appreciated, the removable storage unit 2618 may include a computer usable storage medium having stored therein computer software and/or data. Secondary memory 2610 may also include memory unit 710.

In alternative illustrative embodiments, secondary memory 2610 may include other similar devices for allowing computer programs or other instructions to be loaded into computer system 2600. Such devices may include, for example, a removable storage unit 2622 and an interface 2620. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 2622 and interfaces 2620, which may allow software and data to be transferred from the removable storage unit 2622 to computer system 2600.

Computer 2600 may also include an input device 2603 which may include any mechanism or combination of mechanisms that may permit information to be input into computer system 2600 from, e.g., a user. Input device 2603 may include logic configured to receive information for computer system 2600 from, e.g. a user. Examples of input device 2603 may include, e.g., but not limited to, a mouse, pen-based pointing device, or other pointing device such as a digitizer, a touch sensitive display device, and/or a keyboard or other data entry device (none of which are labeled). Other input devices 2603 may include, e.g., but not limited to, a biometric input device, a video source, an audio source, a microphone, a web cam, a video camera, a light-sensitive device, and/or other camera. Still other input devices 2603 may include, e.g., but not limited to, an imaging device, a light-sensitive device, sensing elements, accelerometers, gyroscopes, GPS, and/or magnetometers.

Computer 2600 may also include output devices 2615 which may include any mechanism or combination of mechanisms that may output information from computer system 2600. Output device 2615 may include logic configured to output information from computer system 2600. Embodiments of output device 2615 may include, e.g., but not limited to, display 2601, and display interface 2602, including displays, printers, speakers, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), etc. Computer 2600 may include input/output (I/O) devices such as, e.g., (but not limited to) input device 2603, communications interface 2624, cable 2628 and communications path 2626, etc. These devices may include, e.g., but are not limited to, a network interface card, and/or modems.

Communications interface 2624 may allow software and data to be transferred between computer system 2600 and external devices.

In this document, the terms “computer program medium” and “computer readable medium” may be used to generally refer to media such as, e.g., but not limited to, removable storage drive 2614, a hard disk installed in hard disk drive 2612, memory unit, flash memories, removable discs, non-removable discs, etc. In addition, it should be noted that various electromagnetic radiation, such as wireless communication, electrical communication carried over an electrically conductive wire (e.g., but not limited to twisted pair, CAT5, etc.) or an optical medium (e.g., but not limited to, optical fiber) and the like may be encoded to carry computer-executable instructions and/or computer data that embodiments of the invention on e.g., a communication network. These computer program products may provide software to computer system 2600. It should be noted that a computer-readable medium that comprises computer-executable instructions for execution in a processor may be configured to store various embodiments of the present invention. References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic.

Further, repeated use of the phrase “in one embodiment,” or “in an illustrative embodiment,” do not necessarily refer to the same embodiment, although they may. The various embodiments described herein may be combined and/or features of the embodiments may be combined to form new embodiments.

Unless specifically stated otherwise, as apparent from the following discussions, it is appreciated that throughout the specification discussions utilizing terms such as “processing,” “computing,” “calculating, ” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments may be embodied in many different ways as a software component. For example, it may be a stand-alone software package, or it may be a software package incorporated as a “tool” in a larger software product, such as, for example, a scientific modeling product. It may be downloadable from a network, for example, a website, as a stand-alone product or as an add-in package for installation in an existing software application. It may also be available as a client-server software application, or as a web-enabled software application. It may also be part of a system for detecting network coverage and responsiveness. A general purpose computer may be specialized by storing programming logic that enables one or more processors to perform the techniques indicated herein and the steps of or descriptions shown in, for example, FIGS. 6-7.

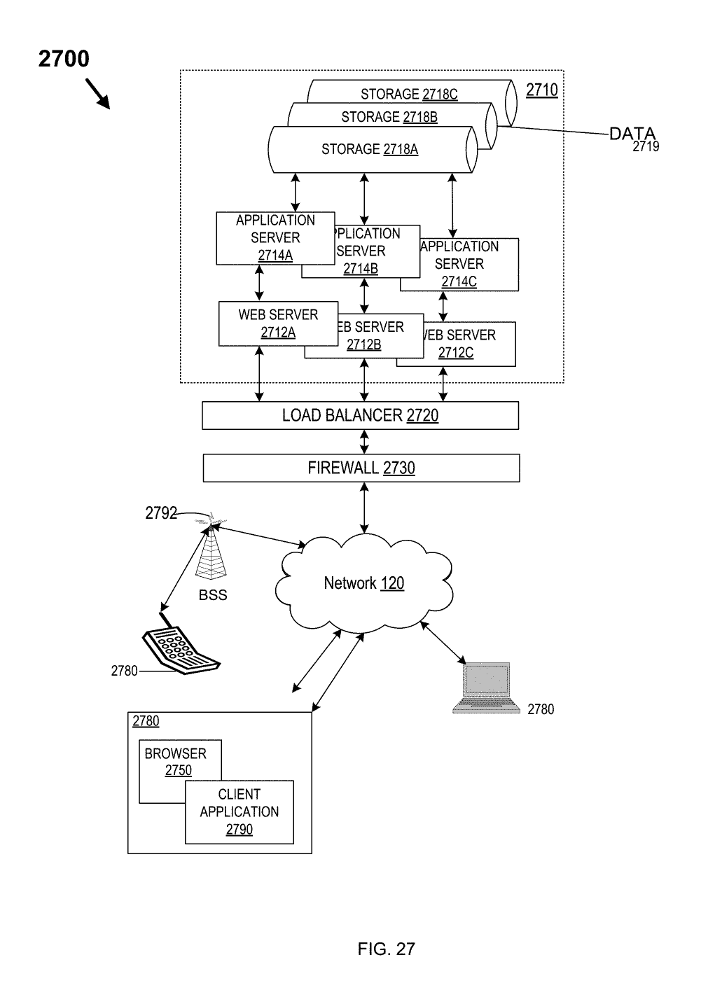

FIG. 27 depicts an example high-level view of an illustrative embodiment of a workflow storage and distribution system 2700 according to an illustrative embodiment of the present invention. The workflow communication and/or computing device 2710 may create, store, transmit, and receive electronic transmissions. The workflow communication and/or computing device 2710 may provide data storage for multiple workflows and context information. Workflow communication and/or computing device 2710 may also allow for data transactions to and from various client devices 2780. Both the workflow communication and/or computing device 2710 and the client devices 2780 may be a computing device 2600 or any other device capable of interacting with communications path 120. The client devices 2780 may be mobile devices that may wirelessly transmit data and voice information with the base station subsystem (BSS) 2792. The BSS 2792 may be responsible for handling traffic and signaling between a mobile device 2780 and the communication path 120.

The client devices 2780 may be equipped with a dedicated workflow application 2790 that may provide the workflow functionality described in the paragraphs above. Alternatively, client devices 2780 may contain a browser 2750 (e.g., but not limited to, Internet Explorer, Firefox, Safari, Opera, etc.), which may, in conjunction with web server 2712, provide the same functionality as the dedicated workflow application 2790.

The physical or logical storage unit 2718 may, for example, store workflow data 2719, queries, product and services ratings, text or video, photographs, audio, text, marketing information, product information, and client data. The stored data 2719 may be stored and used for data mining purposes to calculate, for example, marketing trends over time and efficacy of products and services. The servers 2712 and 2714 may be coupled to client devices 2600 through a communications path 120 (e.g., but not limited to, the Internet) via a load balancer 2720 and a firewall 2730.

According to another embodiment (not shown), the distribution system 2700 could be represented by any of a number of well-known network architecture designs including, but not limited to, peer-to-peer, client-server, hybrid-client (e.g., thin-client), or standalone. A standalone system (not shown) may exist where information may be distributed via a medium such as, e.g., a computer-readable medium, such as, e.g., but not limited to, a compact disc read only memory (CD-ROM), and/or a digital versatile disk (DVD), BLUERAY®, etc. Any other hardware architecture such as, e.g., but not limited to, a services oriented architecture (SOA) could also be used.

Embodiments of the present invention may include apparatuses for performing the operations herein. An apparatus may be specially constructed for the desired purposes, or it may comprise a general purpose device selectively activated or reconfigured by a program stored in the device.

Embodiments may be embodied in many different ways as a software component. For example, it may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, or as a web-enabled software application.

While various embodiments of the present invention have been described above, it should be understood that they have been presented by way of example only, and not limitation. Thus, the breadth and scope of the present invention should not be limited by any of the above-described illustrative embodiments, but should instead be defined only in accordance with the following claims and their equivalents.

Computer Code Listing

What is claimed is:

1. A networked database management system (DBMS), comprising:
a computer accessible data storage, comprising a database remotely located from a plurality of user nodes and a plurality of venue nodes, wherein the remote database comprises:
a plurality of records, wherein the records comprise: user node data, venue node data, and transaction data;
an access control module in data communication with the data storage and configured to prevent unauthorized access to the database;
a communication module in data communication with the data storage and configured to receive user node data and venue node data for storage in the database and query requests to retrieve user node data and venue node data from the database; and
a matching module in communication with the data storage and configured to:
compare one or more venue objects to query information received from a first user node,
provide one or more venue objects to the first user node via the communications module,
set a hold on a venue obj ect of the one or more venue objects for the first user node,
prohibit assigning the venue object to the first user node if the venue object was held previously by one or more other user nodes,
issue a challenge from the first user node to the one or more other user nodes that previously held the venue object,
receive an accepted challenge from a second user node of the one or more other user nodes and release the hold on the venue object for the first user node based on the accepted challenge, and
create a transaction object and assign the venue object to the second user node using the transaction object.

2. The DBMS of claim 1, wherein the remote database further comprises venue bookings, user transaction, venue halls, and venue timing objects.

3. The DBMS of claim 1, wherein fields of the user node data comprise at least one of: a primary key, a first name, a last name, an email, a phone number, or an address.

4. The DBMS of claim 1, wherein fields of the venue node data comprise at least one of: a primary key, a user foreign key, a title, a description, an address, a price, a buyout value, and a status value.

5. The DBMS of claim 4, wherein an address field is competed using GPS coordinates supplied by a venue node of the plurality of venue nodes.

6. The DBMS of claim 1, wherein, the fields of the transaction data comprise at least one of: a primary key, a user foreign key, a venue foreign key, a hall foreign key, a client value, a guest value, a guest type, a date, a booking date, a timeslot, a status, an amount, a buyout value, and sales contact information.

7. The DBMS of claim 1, wherein a webpage module provides a graphical representation of the database.

8. The DBMS of claim 1, wherein the user node is a mobile device.

9. A networked system where a plurality of end nodes interface with a database, the system comprising:
one or more processors;
the database in communication with the one or more processors, the database comprising:
one or more user objects, each user object including: a primary key field, a first name field, a last name field, an email field, a phone number field, and an address field,
one or more venue objects, each venue object including: a primary key field, a foreign key field, and an address field,
one or more transaction objects, each transaction object including: a primary key field and one or more foreign key fields;
a memory in communication with the one or more processors, the memory containing instructions executable by the one or more processors to:
create a plurality of venue objects based on received venue data, the venue data being received by one or more venue nodes of the plurality of end nodes;
create a plurality of user objects based on received user data, the user data being received by one or more user nodes of the plurality of end nodes;
search the plurality of venue objects based on received location information, date range, and number of attendees from the one or more user nodes and retrieve available venues from the database based on the location information, date range, and number of attendees;
provide the available venues to the one or more user nodes;
create a first transaction object based on a received first hold request from a first user node for a selected venue on a selected date and place a first hold on the selected venue on the selected date for the first user node;
create a second transaction object based on a received second hold request from a second user node for the selected venue on the selected date and place a second hold on the selected venue on the selected date for the second user node;
create a third transaction object based on a received third hold request from a third user node for the selected venue on the selected date and place a third hold on the selected venue on the selected date for the third user node;
create a challenge request for the third user node to the first user node and the second user node;
transmit the challenge request to the first user node and the second user node;
receive an accepted challenge from the second user node;
release the third hold on the selected venue on the selected date after the accepted challenge by the second user node;
transmit a first notice of a release of the third hold to the third user node;
release the first hold on the selected venue on the selected date after a period of time from the transmission of the challenge to the first user node;
transmit a second notice of a release of the first hold to the first user node; and
transmit a notice of acceptance to the second user node after receipt of the accepted challenge and after the period of time from the transmission of the challenge to the first user node.

10. The networked system of claim 9, wherein the challenge is issued after the third user node completes one or more application requirements.

11. The networked system of claim 9, wherein the challenge is accepted from the second user node after the second user node completes one or more application requirements.

12. A database device comprising:
a communication module in communication with a plurality of venue nodes and a plurality of user nodes;
one or more processors;
a database in communication with the one or more processors, the database comprising:
one or more user objects, each user object including: a primary key field, a first name field, a last name field, an email field, a phone number field, and an address field,
one or more venue objects, each venue object including: a primary key field, a foreign key field, and an address field,
one or more transaction objects, each transaction object including: a primary key field and one or more foreign key fields;
a memory in communication with the one or more processors, the memory containing instructions executable by the one or more processors to:
create a plurality of venue objects based on received venue data, the venue data being received by the plurality of venue nodes;
create a plurality of user objects based on received user data, the user data being received by the plurality of user nodes;
search the plurality of venue objects based on received location information, date range, and number of attendees from one or more user nodes of the plurality of user nodes and retrieve available venues from the database based on the location information, date range, and number of attendees;
provide the available venues to the one or more user nodes;
create a first transaction object based on a received first hold request from a first user node for a selected venue on a selected date and place a first hold on the selected venue on the selected date for the first user node;
create a second transaction object based on a received second hold request from a second user node for the selected venue on the selected date and place a second hold on the selected venue on the selected date for the second user node;
create a third transaction object based on a received third hold request from a third user node for the selected venue on the selected date and place a third hold on the selected venue on the selected date for the third user node;
create a challenge request for the third user node to the first user node and the second user node;
transmit the challenge request to the first user node and the second user node;
receive an accepted challenge from the second user node;
release the third hold on the selected venue on the selected date after the accepted challenge by the second user node;
transmit a first notice of a release of the third hold to the third user node;
release the first hold on the selected venue on the selected date after a period of time from the transmission of the challenge to the first user node;
transmit a second notice of a release of the first hold to the first user node; and
transmit a notice of acceptance to the second user node after receipt of the accepted challenge and after the period of time from the transmission of the challenge to the first user node.

13. The device of claim 12, wherein the challenge is issued after the third user node completes one or more application requirements.

14. The device of claim 12, wherein the challenge is accepted from the second user node after the second user node completes one or more application requirements.
